(19) United States
(12) Patent Application Publication
(10) Pub. No.: US 2025/0167720 A1
(43) Pub. Date: May 22, 2025

(54) MULTIPLE CABLE, COLUMN AND BEAM STRUCTURES FOR SUPPORTING SOLAR PANELS WITHIN A STRUCTURAL GRID

(71) Applicant: P4P ENERGY LLC D/B/A CONGER SOLAR, Carbondale, CO (US)

(72) Inventor: Steven J. Conger, Carbondale, CO (US)

(21) Appl. No.: 18/843,176

(22) PCT Filed: Oct. 29, 2022
(86) PCT No.: PCT/US2022/078945

§ 371 Date: Aug. 30, 2024

Related U.S. Application Data
(60) Provisional application No. 63/335,930, filed on Apr. 28, 2022.

(51) Int. Cl. H02S 20/10; H02S 20/30; H02S 40/10

(52) U.S. Cl. CPC H02S 20/10; H02S 40/10; H02S 20/30

(57) ABSTRACT

Embodiments of the invention include structural grids that support loads such as solar panels and enable the solar panels to be suspended above the ground in any desired orientation. The structural grids include a group of structural support elements that include vertical or angled columns, beams, cables, and connectors that attach the support elements to one another. Groups of beams may be configured in trusses to achieve dedicated support along the structural grid locations needing additional support. The structural grids can be employed in a number of different commercial installations where solar panels may be desired. Specific embodiments of the invention can be used over bodies of water, in areas such as landfills, or in areas that have obstacles which requires the structural grids to have irregular and non-linear shapes.

### CROSS REFERENCE TO RELATED APPLICATIONS

This application claims the benefit of and priority to U.S. Patent Application No. 63/335,930, filed Apr. 28, 2022. The entire specification and figures of the above-referenced application are hereby incorporated, in their entirety by reference.

### FIELD OF THE INVENTION

The present invention is related to the field of structural supports for solar panels, and more particularly, to devices and systems relating to structural supports to support photovoltaic (PV) solar panels with various combinations of cables, columns, beams, anchors and other support elements in a wide variety of commercial applications.

### BACKGROUND OF THE INVENTION

In recent years, there has been an increased urgency for producing electrical power from renewable energy as opposed to power produced by traditional oil and gas sources. Recent global warming predictions stress the need for vastly reducing worldwide carbon emissions in order to prevent what is projected to be catastrophic temperature increases over the next century. The use of solar energy is well known for the production of electrical power; however, in most countries, solar energy only accounts for a small percentage of power produced.

One of the drawbacks with solar power is the efficiency of PV cells to produce power as compared to the amount of energy that can be produced by a relatively small amount of an oil/gas resource. Considering the discrepancy between the efficiency of PV technology as compared to oil/gas, considerable improvements have been made to increase the efficiency of PV cells which has enabled solar power to be more competitive alternative as a source of energy. In addition to a comparison of the basic technology of PV cells as compared to other renewable energy sources and oil/gas resources, most of the past designs associated with supporting solar panel arrays required a significant number of materials. For example, earlier support designs for solar panel arrays required an excessive number of large iron or steel members. Therefore, the cost to install a solar panel was in large part a function of the cost of the materials that were required to support the solar panels when installed.

Some examples of prior art that disclose the use of the cable supported structures for solar panel arrays include the U.S. Pat. Nos. 7,285,719; 8,278,547; 8,381,464; 9,027,288, and 9,564,851, by inventor Steven Conger. These US patents disclose a wide variety of different cable supported structures that can be installed to save on materials as compared to traditional solar panel support structures.

Despite many advances in PV technology, there are still needs for solar panel systems in which fewer and less expensive materials are used for installation. There are also new opportunities for installation of solar panel systems to provide electrical power in locations that could not previously employ solar panel systems because of rough terrain or because of an inadequate amount of land available for installation.

### SUMMARY OF THE INVENTION

Embodiments of the invention include devices and systems relating to structural supports to support PV solar panels with various combinations of cables, columns, beams, anchors and other support elements for in a wide variety of commercial applications.

In connection with the embodiments, devices and systems of the invention include the support elements that are designed to decrease the amount of structural steel used by increasing the use of cables. Steel cables are extremely strong and resilient structural members for use in tension loads. These cables are used to replace traditional structural steel designs resulting in these significant decrease in cost for constructing the structural supports. Some structural steel members are used, for example, to provide a vertical lift to suspend the solar panels above the ground or in some cases to provide compression support. However, the devices and systems of the invention are optimized to limit the number of structural steel members, yet the invention still providing structurally robust supports to handle all types of loads experienced to include tension, compression, and torsional loads.

Embodiments of the invention maybe described as cable and beam structural grids that support the solar panels and which allow the solar panels to be suspended above the ground. The embodiments may be further described as a structural grid including cables that extend along a first axis, such as an axis that extends substantially horizontal with respect to the ground, and beams that extend in a substantially perpendicular or second axis, the second axis extending substantially perpendicular to the ground.

The term “beam” as used herein defines a rigid structural support member that extends horizontally, vertically, or at some other angular orientation in relation to the ground. The term “column” as used herein defines a rigid structural support member that more specifically is vertically oriented. The term “brace” as used herein defines a rigid structural support member that more specifically is oriented to extend between and substantially perpendicular or angularly with respect to two beams of a structural grid. The term “truss” as used herein may define a connected group of rigid structure support members or a group of flexible support members such as a group of cables, which are used to support a defined length or width of a span.

Alternatively, the term “truss” may define a composite or mixed group of rigid or flexible support members, such as a combination of cables and rigid structural members used to support a defined length or width of a span. Further definitions or limitations of the term “truss’ may be set forth within the descriptions of the embodiments provided herein.

Embodiments of the invention may include one or more tensioning beams or trusses which are connected to tensioning cables that extend between the tensioning beams or trusses and ground anchors.

Embodiments of the invention may further include intermediate supports that may comprise a combination of beams or trusses supported by columns that are anchored to the ground. The intermediate supports may be selectively spaced along the length of a solar panel array.

Embodiments of the invention are optimized for the loading conditions encountered in which the frequency or density of the cables and beams can be increased or decreased based on the loading conditions. For example, the number of cables extending between a width and length of a solar panel array may be increased to account for heavier loading conditions whereas the number of cables may also be decreased to account for lighter loading conditions. Increasing the number of cables reduces the span of the adjacent beams thereby also reducing the required beam size and weight. By transferring a greater percentage of the load to the cables, this design thereby saves significant cost in the usage of steel beams.

Embodiments of the invention that require greater stability to handle increased torsional and bending forces may include structural beams that extend along the first or horizontal axis, resulting in a structural grid that includes both horizontal and vertical beams in combination with the cables.

Some embodiments of the invention are designed to handle both loads that are oriented above and below the cables. For example, a solar panel array may represent a load that is oriented or located above the cables and a membrane or cover may represent a load that is located below the cables. In this example, the invention could be used as a parking structure in which the solar panels are used to produce power while the membrane or cover is used to provide shade for the underlying vehicles.

Embodiments of the invention may be further defined as including a structural grid with structural trusses that include horizontal beams located in the first axis and oriented at desired angular orientations in order to provide additional structural support to an overlying or underlying load. For example, a truss could be defined as a plurality of beams that are oriented both laterally across and longitudinally along a group cables to support a number of solar panels. Further, a truss can be defined as a plurality of beams that are oriented in a combination of lateral, longitudinal and diagonal directions upon the cables.

Embodiments of the invention incorporate cable tensioning in order to provide the necessary structural support for loading conditions to include live and dead loads. For example, depending upon the location in which the invention is installed, and considering various factors such as the slope of the underlying ground, typical wind conditions and other factors, cable tensioning may vary in terms of the looseness or tightness of the cables in a particular installation. Tightening or loosening of cables may be facilitated by cable bolt connectors that are selectively tensioned by hydraulic tensioning devices or bridge sockets.

Embodiments of the invention may be installed as linear extending structural grids or as curved structural grids in which the arrangement of cables and beams enable the solar panels to cover both straight and curved areas. This feature of the invention is particularly advantageous because there can be limited space for installing the invention in which one or more obstacles may be present within a designated area in which sections of the structural grid need to be straight or linear, while others may need to be curved.

Embodiments of the invention may include a solar panel cleaning feature comprising a service trolley that is installed upon the structural grid, the trolley being capable of moving along one or more selected directions of a structural grid.

Embodiments of the invention can be defined as short, medium, or long span systems in which the particular width and length they structural grid can be designed to extend over relatively short order relatively long spans. The number and density of cables and beams is selected to provide the necessary support based upon the span desired.

One embodiment of the invention may be especially adapted for extending over a body of water such as an irrigation ditch, river, pond, or other body of water. In this embodiment, solar panels may extend over a body of water in which opposite sides of the solar panels are secured by vertical columns or beams located at opposite sides of the body of water.

Another embodiment of the invention may be especially adapted for extending over a landfill in which an adjustable tilt feature is provided for the solar panels.

Yet another embodiment of the invention may be especially adapted for serving as a parking structure in which a membrane or cover is suspended from below the structural grid to provide shade for the vehicles parked under the parking structure. For example, if the desired activity is to provide a shaded parking lot, the vertical beams are provided at a height enabling vehicles to be parked beneath the structural grid, and the columns may be spaced apart to create a sheltered area sized to correspond to the desired area of the parking lot.

It should be understood that embodiments of the invention can be configured such that the structural grids provide support for loads in tension, compression, or combinations of both. The cables are allowed to be suspended or hang with a curvature determined by the amount of tension placed on the cables between opposing vertical beams, these beams also being defined as vertical stationary supports.

Embodiments of the invention may include cables that are arranged substantially parallel and planar with one another. Alternatively, the cables can be arranged in a first group of substantially parallel cables and a second group of substantially parallel cables that are vertically offset were spaced from the first group. Further, one or more vertically oriented interconnecting cables may be used to interconnect upper and lower sets of groups of cables. The combination of upper cables, lower cables, and interconnecting cables can be defined as a cable truss. Multiple cable trusses can be used to support a load.

In some embodiments of the invention, the structural grid can define a free-standing structure in which the loads are supported only by the group of cables and beams. In other embodiments, the structural grid may be supported at one end by an existing structure such as a hillside, building, or other vertically extending feature.

The invention includes a capability to selectively adjust the tensioning of cables either by one or more tensioning devices mounted directly to the cable trusses, or by separate tensioning devices. Tensioning of cables can be achieved by one or more designated tensioning cables that extend laterally across the or longitudinally along a desired length of the structural grid. The tensioning cable may extend in a crisscross pattern in which each crossing length of the tensioning cable passes through a pulley enabling one end of the tensioning cable to be manipulated in order to achieve tensioning across the entire width or length of the structural grid.

Further advantages and features of the devices and systems of the present invention will become apparent from a review of the following figures, along with the detailed description.

### BRIEF DESCRIPTION OF THE DRAWINGS

FIG. 1 is a perspective view of one embodiment of the invention showing a structural grid that may support a load such as a plurality of solar panels;

FIG. 2 is an enlarged portion of FIG. 1;

FIG. 3 is an enlarged portion of FIG. 1 showing the trusses removed to better view the underlying cables;

FIG. 4 is a perspective view of a group of column and beam supports for a structural grid;

FIG. 5 is an enlarged perspective view of one end of FIG. 4 with cables attached to show the general orientation of the group of column and beam supports with the cables;

FIG. 6 is a perspective view of FIG. 4 with the cables attached;

FIG. 7 is a perspective view of FIG. 6 with cables attached and trusses mounted over the cables, thereby defining a structural grid including cables, columns, and trusses comprising groups of beams;

FIG. 8 is a perspective view of FIG. 7 adding a plurality solar panels supported by the structural grid;

FIG. 9 is a plan view illustrating a structural grid component frequency design in which a designated number of cables and beams are provided within a structural grid of a designated width and length;

FIG. 10 is a plan view illustrating another structural grid component frequency in which an increased density of cables and beams are provided within the structural grid;

FIG. 11 is a cross-sectional view of a beam of a structural grid showing the beam located above and connected to a plurality of cables;

FIG. 12 is a cross-sectional view of a cable of a structural gid showing the cable located below and connected to a plurality of overlying beams;

FIG. 13 is a cross-sectional view of a cable of a structural grid showing the cable located below and connected to a plurality of overlying beams and braces extending between the beams;

FIG. 14 is another cross-sectional view of FIG. 13 further showing a load supported by the structural grid, such as a plurality of solar panels;

FIG. 15 is a cross-sectional view of a beam of a structural grid showing the beam located below and connected to a plurality of overlying cables, thereby providing a reversed orientation of the beam and cables as compared to FIG. 11;

FIG. 16 is a cross-sectional view of a cable of a structural gid showing the cable located above and connected to a plurality of underlying beams, thereby providing a reversed orientation of the cable and beams as compared to FIG. 12;

FIG. 17 is a cross-sectional view of a cable of a structural grid showing beams connected to both upper and lower sides or surfaces of the cable;

FIG. 18 shows the cross-sectional view of FIG. 17 adding a plurality of upper and lower loads, such as upper solar panels and lower shading elements, mounted respectively to the upper and lower beams;

FIG. 19 is a perspective view of a structural grid showing cables, beams, and interconnecting braces between the beams;

FIG. 20 is a perspective view of FIG. 19 adding a first load over the beams, shown as a transparent or translucent layer of material in order to better view the underlying cables and beams;

FIG. 21 shows the perspective view of FIG. 19 showing the load mounted over the beams and cables as a solid load, such as solar panels;

FIG. 22 is a side elevation view or a plan view of a truss that can be used in a structural grid wherein the truss can be vertically or horizontally oriented, or may be oriented at any angle between the vertical and horizontal, to provide structural support one or more loads;

FIG. 23 is a side elevation view or a bottom plan view of the truss of FIG. 22 showing the truss supporting a plurality of overlying beams and a load such as a plurality of solar panels;

FIG. 24 is a side elevation view of an intermediate support for a structural grid, including a pair of columns that supports opposite sides of the structural grid;

FIG. 25 is a side elevation view of another intermediate support for a structural grid, including a pair of columns in which the structural grid also includes a truss;

FIG. 26 is a perspective view of intermediate supports for a structural grid wherein the intermediate supports are in the form of T-column supports comprising a central column and a laterally extending beam bisected by the central column;

FIG. 27 is an elevation view of a structural grid supporting a load such as a plurality of solar panels in which a tensioning truss is used to provide additional structural support to the structural grid at one end of the structural grid;

FIG. 28 is an enlarged elevation view of a portion of FIG. 27 showing the tensioning truss located at the end of the structural grid;

FIG. 29 is an enlarged elevation view of a tensioning truss located between sections or bays of two adjacent structural grids;

FIG. 30 is a plan view of the truss shown in FIG. 29 and the solar panel load on one side of the truss.

FIG. 31 is the plan view of FIG. 30 further adding a load on the left side of the figure, such as additional solar panels.

FIG. 32 is an elevation view of a beam and beam to cable connectors in which the connector is mounted to the upper surface of the beam;

FIG. 33 is an enlarged view of one end of FIG. 32;

FIG. 34 is an enlarged view of one of the beam to cable connectors with a top compression plate installed;

FIG. 35 is an elevation view of another beam and beam to cable connectors in which the connector is mounted to the lower surface of the beam;

FIG. 36 is an enlarged view of one of the beam to cable connectors of FIG. 35 with a bottom plate removed;

FIG. 37 is an enlarged view of the beam to cable connector of FIG. 36 showing the bottom compression plate installed;

FIG. 38 is a plan view of one example of a structural grid assembled to cover a curved area;

FIG. 39 is the plan view of FIG. 39 adding an arrangement of cables;

FIG. 40 is the plan view of FIG. 39 further adding an arrangement of beams incorporated with the cables;

FIG. 41 is the plan view of FIG. 40 further adding an arrangement of loads such as solar panels;

FIG. 42 is a perspective view of intermediate supports for a structural grid wherein the intermediate supports are provided in the form of trusses that are arranged for the structural grid to cover a long span, such as a span crossing a large body of water;

FIG. 43 is the perspective view of FIG. 42 further adding a plurality of cables and adding an additional truss located near one end of the structural grid, this figure representing a long span embodiment of the invention;

FIG. 44 is the perspective view of FIG. 43 further adding a plurality of trusses each containing multiple beams, noting the cables are deleted for clarity to more easily visualize the arrangement of the trusses;

FIG. 45 is a perspective view of the embodiment of FIG. 43 and further adding a load, such as a plurality of solar panels;

FIG. 46 is a cross-sectional view of a portion of a structural grid including a service access/automatic cleaning trolley assembly supported by a rail;

FIG. 47 is a plan view showing an arrangement of two rails that can be used to convey the service access/automatic cleaning trolley assembly along any desired length of a structural grid;

FIG. 48 is a cross-sectional elevation view of a sample structural grid in which two rails are provided to each support a trolley assembly and wherein the trolley assemblies are shown to support a cleaning tube extending between the trolley assemblies;

FIG. 49 is another cross-sectional elevation view similar to FIG. 48 wherein the trolley assemblies are alternatively shown to each support respective pieces of service equipment;

FIG. 50 is an enlarged view of the service access/automatic cleaning trolley assembly of FIG. 46;

FIG. 51 is a perspective view of structural supports for a structural grid as employed for a continuous canopy embodiment of the invention, the structural supports including a number of spaced beam and column combinations including intermediate columns and beams with diagonal bracing;

FIG. 52 is a perspective view of FIG. 51 showing a load added to the system such as solar panels in which a continuous canopy or covering of the area is achieved and wherein the solar panels are selectively angled in a pattern that presents apexes and troughs that may be advantages for sunlight capture, shading or combinations thereof;

FIG. 53 is a perspective view of a short span system of the invention provided to illustrate that only a minimum number of structural supports are employed in a simplified structural grid as compared to prior art systems in which a much greater number of rigid structural supports are required;

FIG. 54 is the perspective view of FIG. 53 further adding a plurality of trusses to form the structural grid;

FIG. 55 is a perspective view of FIG. 54 further showing a load added to the structural grid such as solar panels;

FIG. 56 is a side elevation view of another structural grid embodiment of the invention showing a structural grid that is especially adapted for ground mounting in which the structural grid includes an above-ground base support and a low-profile presentation of solar panels at a desired angular orientation;

FIG. 57 is a side elevation view of the structural grid embodiment of FIG. 56 showing a plurality of rows of structural grids and mounted solar panels spaced from one another on a relatively flat ground surface;

FIG. 58 is a side elevation view of the structural grid embodiment of FIG. 57 showing a plurality of rows of structural grids and mounted solar panels spaced from one another on a sloping ground surface;

FIG. 59 is a perspective view of the structural grid embodiment of FIG. 57 showing the structural grids and mounted solar panels;

FIG. 60 is a perspective view of a structural grid in connection with another embodiment of the invention in the form of a cantilever design in which a first side of the structural grid is anchored and the opposite second side extends away from the first side and the second side is not supported by a column or any other support;

FIG. 61 is the perspective view of FIG. 60 further adding a load such as solar panels on one end of the structural grid;

FIG. 62 is the perspective view of FIG. 61 showing solar panels mounted on both ends of the structural grid and further showing tensioning trusses located on both sides of the structural grid and a tensioning truss located between midway between the two groups of solar panels;

FIG. 63 is the perspective view of FIG. 62 showing the tensioning trusses as being tightened thereby decreasing the widths of the tensioning trusses to indicate increased tensioning support provided by the structural grid; and

FIG. 64 is an enlarged side elevation view of the cantilever design of FIG. 60 showing one of the column and beam combinations making up the structural grid of the embodiment.

### DETAILED DESCRIPTION OF THE INVENTION

The following detailed description is provided with reference to the above-described figures. The figures, which are not necessarily to scale, depict illustrative embodiments of the invention and are not intended to limit the scope of the invention as defined in the appended claims. Accordingly, the embodiments of the invention are provided to explain the various features and advantages of the invention and these embodiments should not be construed to be the only manner in which the invention can be practiced commensurate with the appended claims.

Like reference numbers used in the figures represent the same or substantially the same structural features that are common to the illustrated embodiments in which the like reference numbers appear. However, the figures are not intended to represent every structural feature of every illustrated element and therefore, the names assigned to these elements herein should be interpreted in their broadest meaning without limitations being assigned to these elements that are not within reasonable and acceptable definitions of these elements.

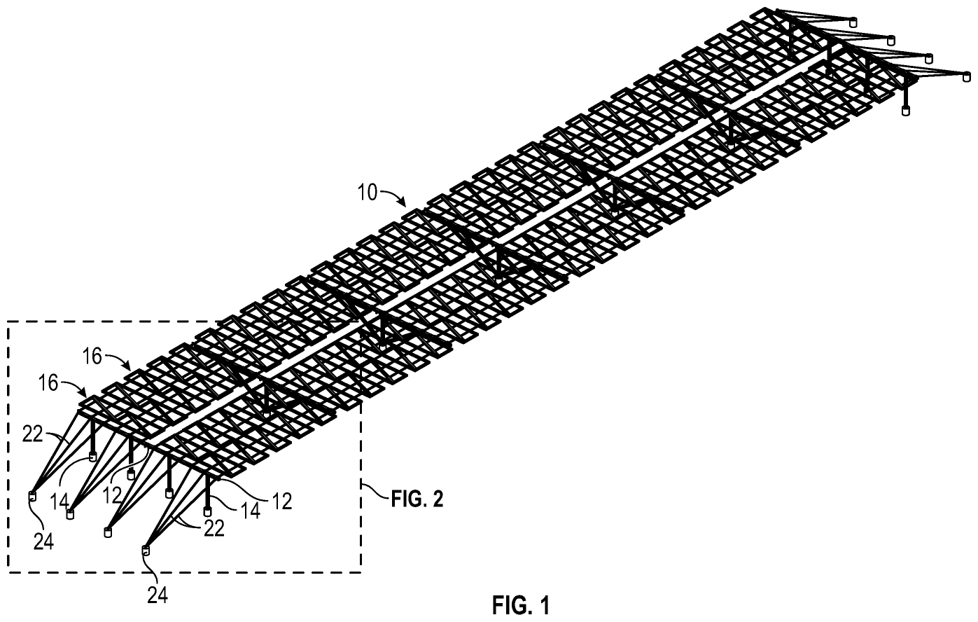

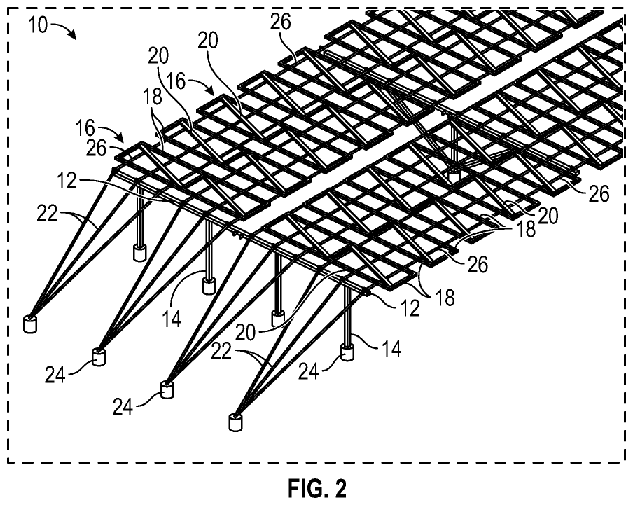

FIG. 1 is a perspective view of one embodiment of the invention showing a structural grid that may support a load such as a plurality of solar panels. Common to this embodiment and the other embodiments that are described herein, is that the structural grid can be considered a combination of various structural support elements used to support a load. The load may comprise any combination of solar panels, flexible coverings such as a covering provided for shade, and other types of loads. FIGS. 1 and 2 more specifically show a system 10 of the invention comprising a plurality of horizontally oriented beams 12, a plurality of vertically oriented columns 14, and a plurality of anchor cables 22 that are connected between the structural grid and the ground to provide additional support for the structural grid as anchor points. These figures also show ground anchors 24 attached to the ends of the anchor cables 22, such as piles or foundations that can provide additional anchoring support. These figures further show a plurality of trusses 16 that rest upon a plurality of support cables 26. As set forth and as illustrated with respect to the other embodiments, there are a great number of different geometric combinations of cables 26 and trusses 16 that can be used to support loads in connection with the structural grid of the invention. The trusses 16 of the invention may be considered rigid structural supports that comprise a plurality of truss beams 18 and braces 20 as shown. The trusses may also be provided in various geometric combinations of beams 18 and braces 20, as will be appreciated from our view of the other embodiments of the invention. The mention of beams 12 and beams 18 herein can be interpreted to mean any type of beam, whether used alone, or within a truss 16.

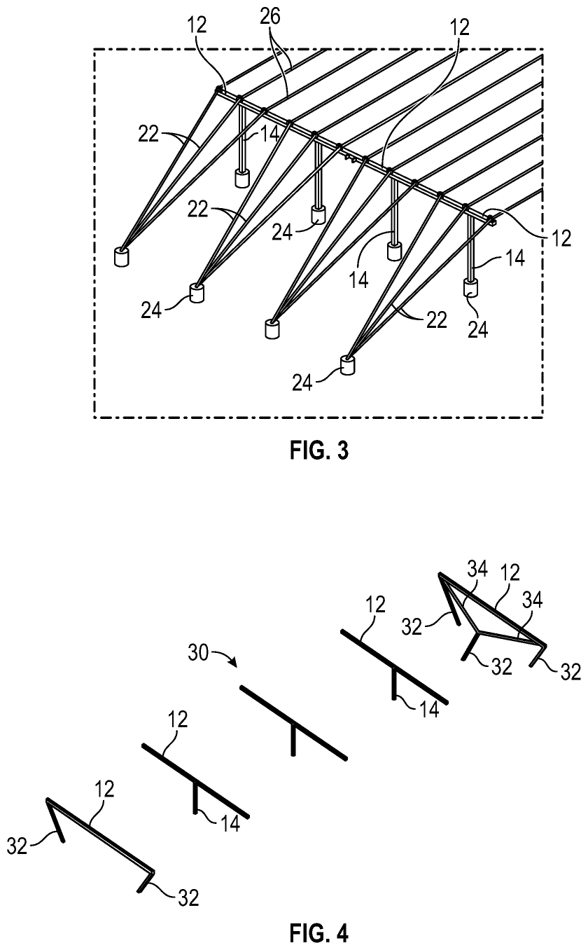

FIG. 3 is an enlarged portion of FIG. 1 showing the trusses removed to better view the underlying cables. The cables 26 are shown as being equally spaced from one another and extending substantially parallel. However, it should also be understood that the cables 26 may be irregularly spaced from one another and may also extend at angles with one another, to include cables being provided in various crisscrossing patterns which may be dictated by the structural load to be supported. further, the cables in FIG. 3 are shown to be oriented substantially planar to one another, but it should also be understood that the cables 26 could also be oriented so that the cables do not extend planar with one another and rather, the cables may extend in irregular patterns in which some cables may be planar with one another and other cables may be non-planar.

FIG. 4 is a perspective view of a group of column and beam supports for a structural grid 30 in connection with another embodiment of the invention. For this structural grid, some emphasis is provided for providing alternative compression strength for the structural grid 30 in which columns 32 are shown as being angled with respect to the ground. One set of columns 32 located at one end of the structural grid includes three angled columns 32 with two intermediate compression columns or braces 34, as shown. Also, the intermediate columns 14 are shown with beams 12 in a T-shape that can be considered one type of intermediate support that can be used.

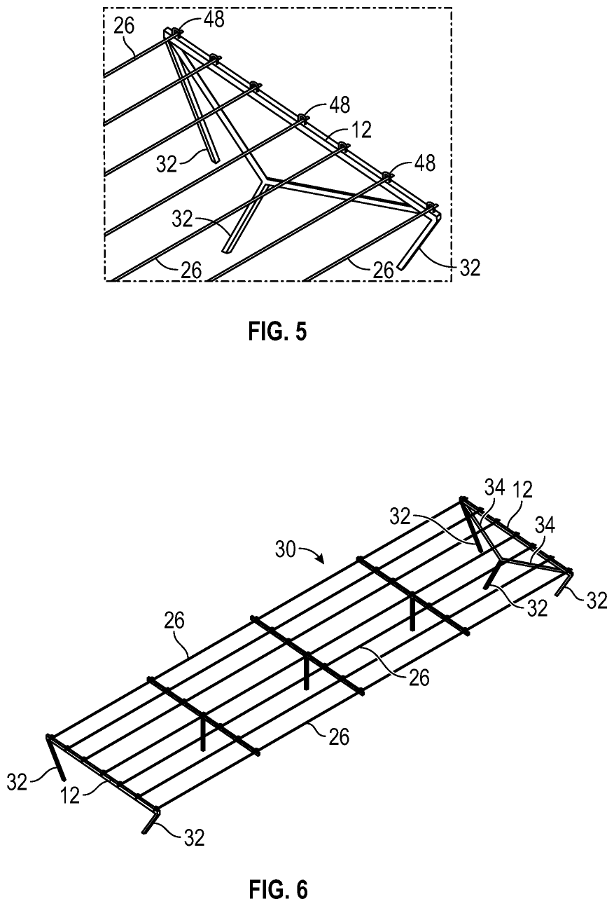

FIG. 5 is an enlarged perspective view of one end of FIG. 4 with cables attached to show the general orientation of the group of column and beam supports with the cables. FIG. 6 is a perspective view of FIG. 4 with the cables attached.

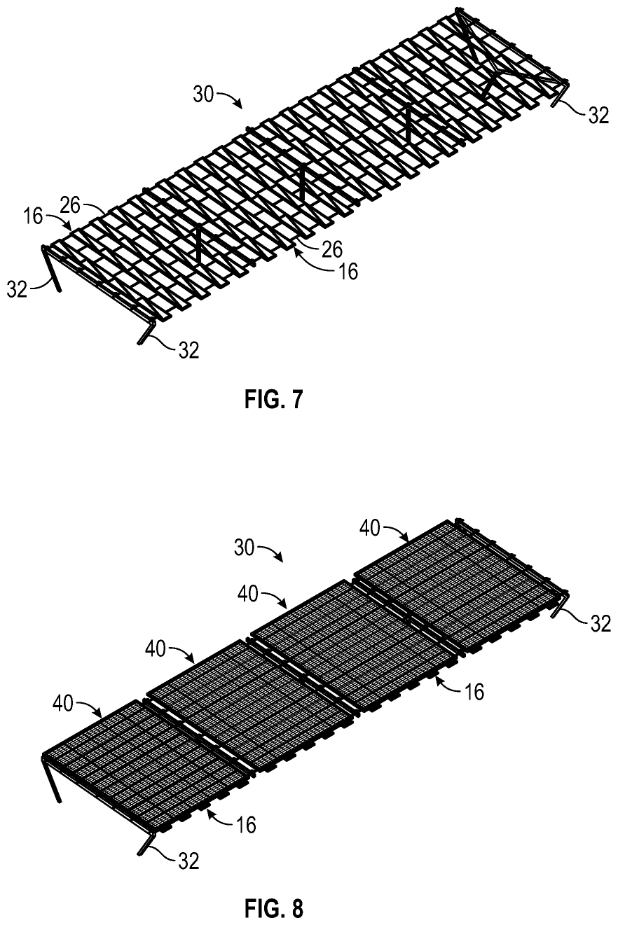

FIG. 7 is a perspective view of FIG. 6 with cables 26 attached and trusses 16 mounted over the cables, thereby defining a structural grid including cables, columns, and trusses. Some even spacing is provided between each of the trusses 16, but it should be understood that spacing of the trusses can be even or irregular across the structural grid. Further, the trusses are shown as being of substantially equal length and width but it should also be understood that the trusses employed do not have to be uniform in length or width for a particular structural grid.

FIG. 8 is a perspective view of FIG. 7 adding a plurality solar panels supported by the structural grid. Four groups of solar panels 40 are shown. The groups of solar panels may also be defined as solar arrays. As shown, the solar panels 40 may have gaps or spaces between the arrays. Alternatively, there can be a continuous or single grouping of solar panels that cover the entire length and width of the structural grid.

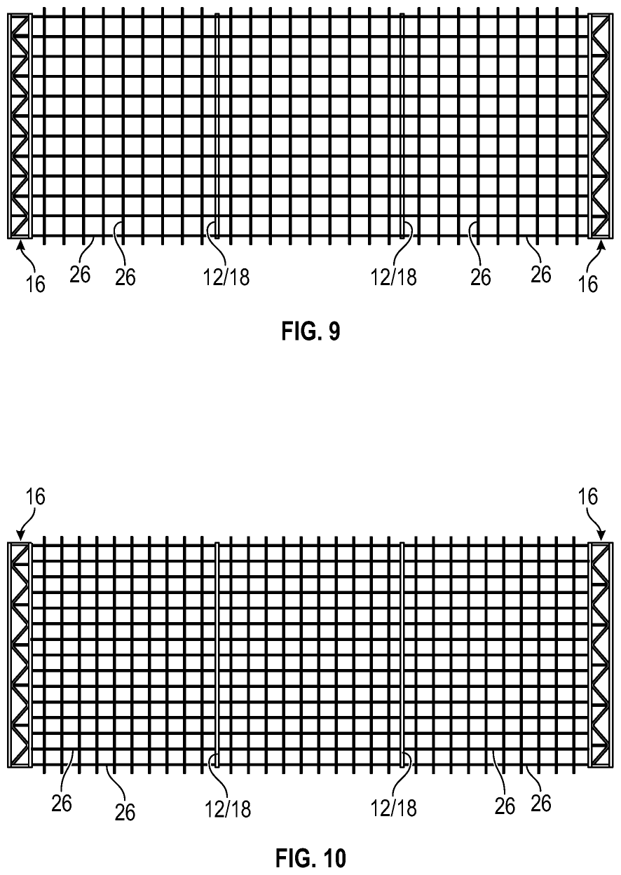

FIG. 9 is a plan view illustrating a structural grid component frequency design in which a designated number of cables and beams are provided within a structural grid of a designated width and length. More specifically, this figure shows a plurality of crossing structural support members which could be cables 26 as shown, or alternatively, could be combinations of beams and cables. Further, this figure shows two beams 12/18, it being understood that these could be separate beams 12 or groups of beams 18 within a truss. This figure also illustrates a truss 16 located at both ends of the structural grid.

FIG. 10 is a plan view illustrating another structural grid component frequency in which an increased density of cables and/or beams are provided within the structural grid. What is intended to be shown in the comparison between FIGS. 9 and 10 is that the density or number of beams and cables and trusses can be selected to provide a structural grid with the required support necessary for the loads to be carried.

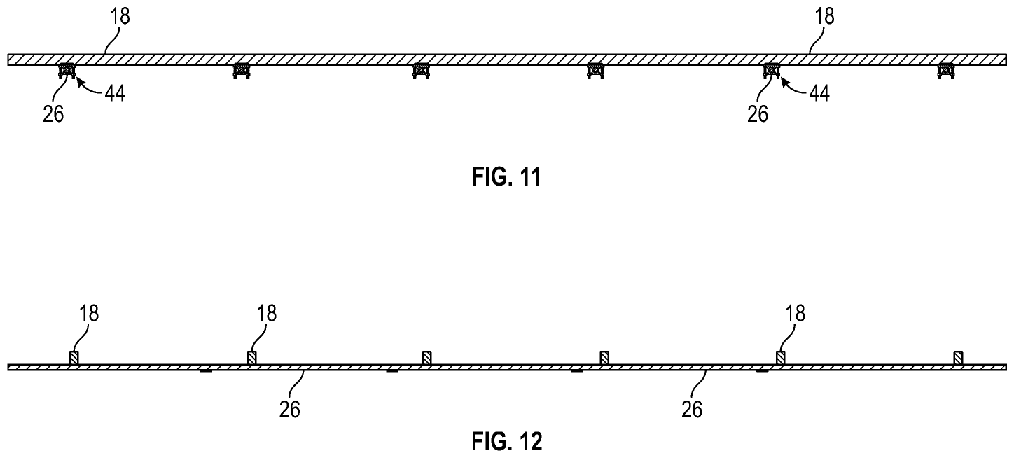

FIG. 11 is a cross-sectional view of a beam 18 of a structural grid showing the beam located above and connected to a plurality of cables 26 by connectors 44.

FIG. 12 is a cross-sectional view of a cable 26 of a structural grid showing the cable located below and connected to a plurality of overlying beams 18. The comparison of FIGS. 11 and 12 therefore indicate that beams of a structural grid may rest upon cables 26 or alternatively, the beams 18 may be supported by the cables 26. These alternative arrangements therefore exemplify that different loading conditions can be applied to a structural grid without having to substantially alter any of the structural members that make up the structural grid.

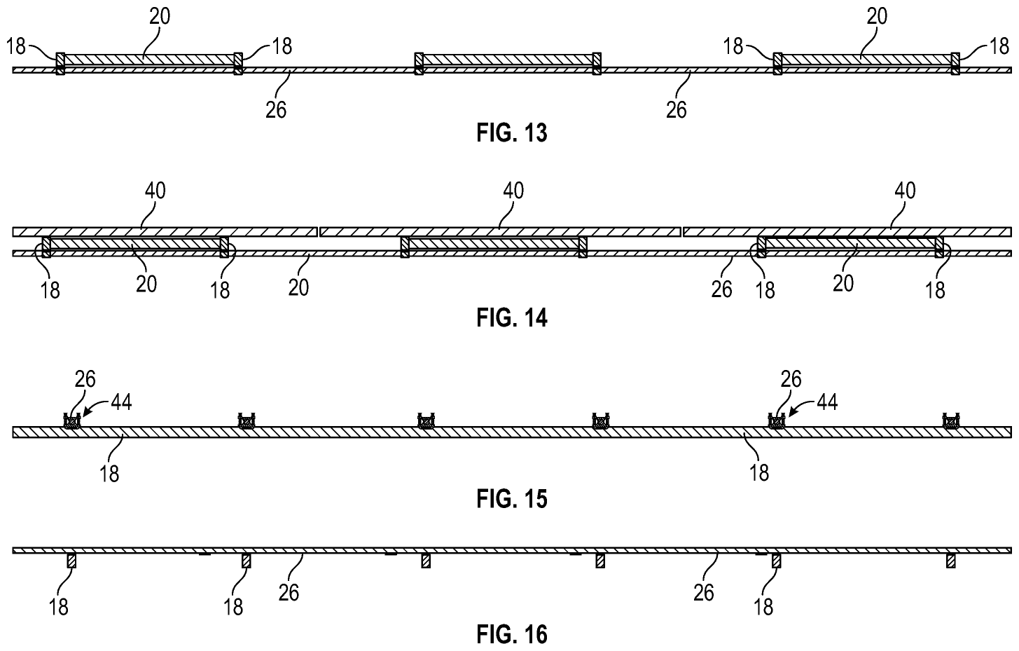

FIG. 13 is a cross-sectional view of a cable 26 of a structural grid showing the cable located below and connected to a plurality of overlying beams 18 and braces 20 extending between the beams, the beams and braces, for example, indicating the use of a truss in the structural grid.

FIG. 14 is another cross-sectional view of FIG. 13 further showing a load supported by the structural grid, such as a plurality of solar panels 40.

FIG. 15 is a cross-sectional view of a beam 18 of a structural grid showing the beam 18 located below and connected to a plurality of overlying cables 26, thereby providing a reversed orientation of the beam and cables as compared to FIG. 11, FIG. 16 is a cross-sectional view of a cable 26 of a structural gid showing the cable located above and connected to a plurality of underlying beams 18, thereby providing a reversed orientation of the cable and beams as compared to FIG. 12, and again noting that these alternative arrangements of beams and cables enable various different loads to be carried by the structural grid.

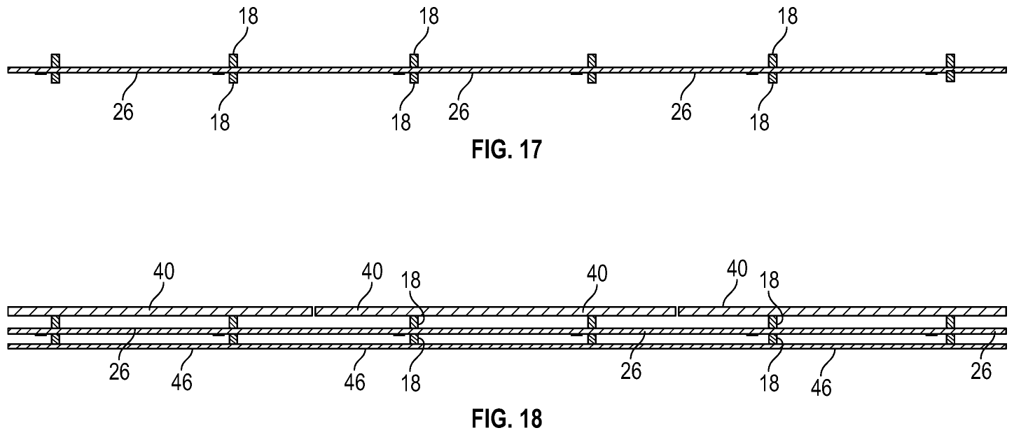

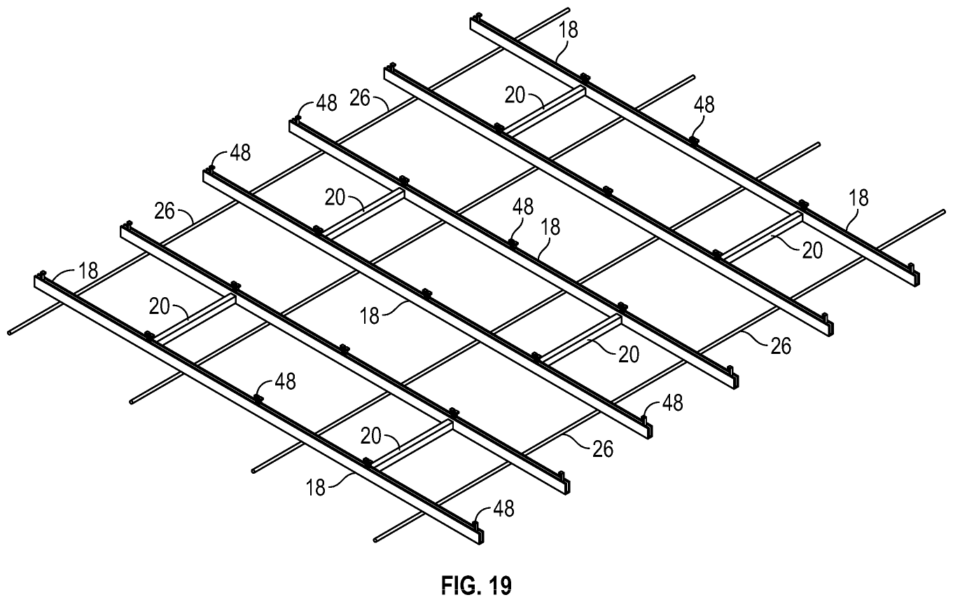

FIG. 17 is a cross-sectional view of a cable 26 of a structural grid showing beams 18 connected to both upper and lower sides or surfaces of the cable 26. FIG. 18 shows the cross-sectional view of FIG. 17 adding a plurality of upper and lower loads, such as upper solar panels 40 and lower shading elements 46, mounted respectively to the upper and lower beams. FIGS. 17 and 18 therefore represent yet another arrangement of cables and beams that can be provided for carrying not only one type of load, but multiple loads within the same structural grid without having to introduce different types of structural support members. Rather, the only design modification required is to provide additional beams and/or cables for the structural grid.

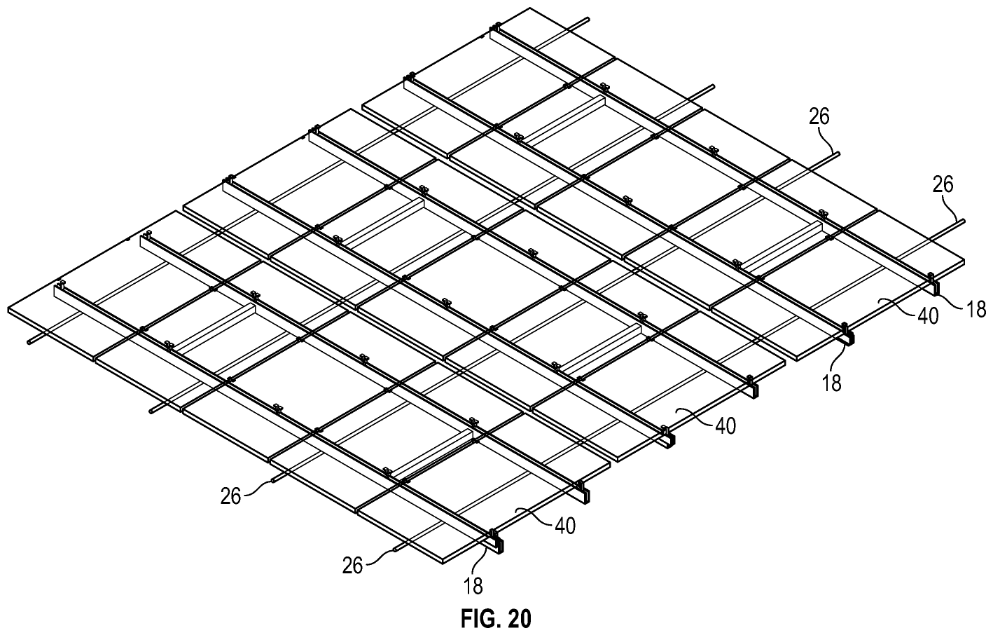

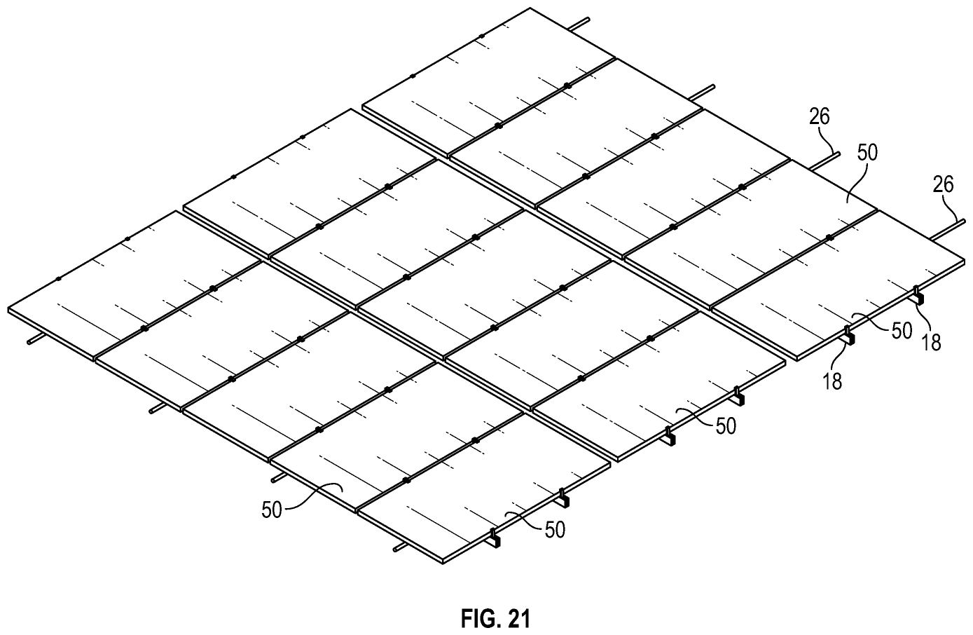

FIG. 19 is a perspective view of a particular arrangement of a structural grid showing cables 26, beams 18, and interconnecting braces 20 located between the beams 18. A plurality of connectors 48 are also shown that represent hardware secured to beams that can be used to attach a load. FIG. 20 is a perspective view of FIG. 19 adding a first load over the beams, shown as a transparent or translucent layer of material in order to better view the underlying cables and beams. FIG. 21 shows the perspective view of FIG. 19 showing the load mounted over the beams and cables as a solid load, such as solar panels 40. What is intended to be shown in these figures is how a minimum number of beams and braces can be used in order to provide adequate support for a load in which the beams are directly connected to the cables, and the beams and braces provide both longitudinal and lateral stiffening support.

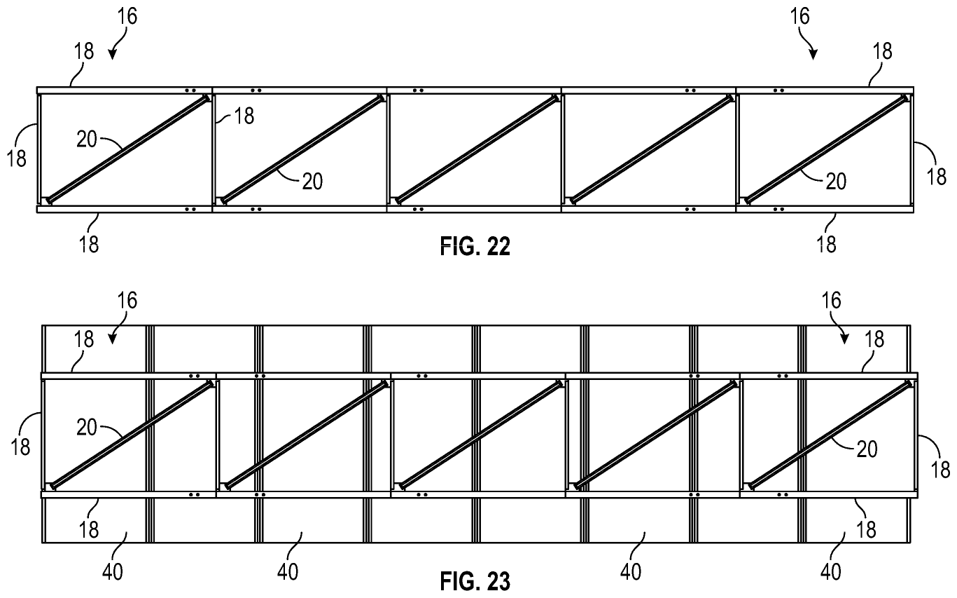

FIG. 22 is a side elevation view or a plan view of a truss that can be used in a structural grid wherein the truss can be vertically or horizontally oriented, or the truss may be oriented at any angle between the vertical and horizontal, to provide structural support one or more loads. As shown, the truss 16 comprises various beams 18 and braces 20 in which the beams are oriented orthogonal and parallel to one another and the braces are oriented diagonally. FIG. 23 is a side elevation view or a bottom plan view of the truss of FIG. 22 showing the truss supporting a plurality of overlying beams and a load such as a plurality of solar panels. These figures illustrate yet another example of a combination of beams that can be arranged in a unitary truss so that stiffening support is provided to a load in lateral, longitudinal and diagonal directions.

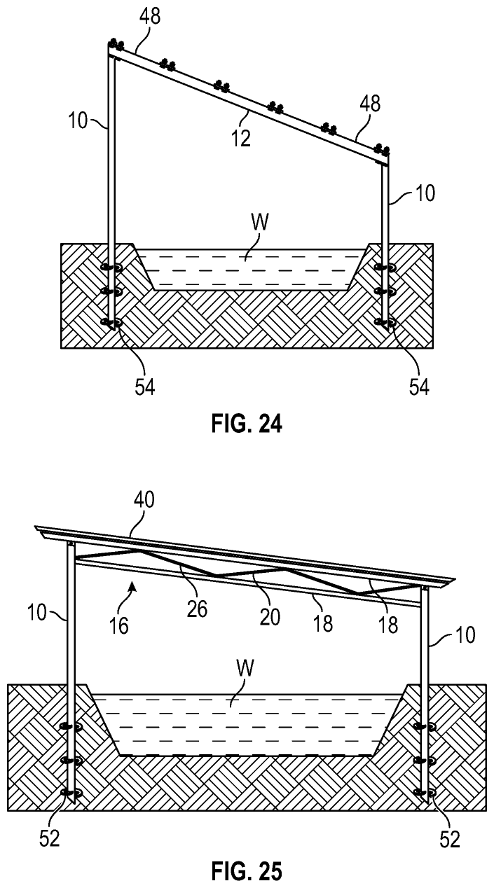

FIG. 24 is a side elevation view of an intermediate support for a structural grid, including a pair of columns 10 that support opposite sides of the structural grid. The columns 10 are shown on opposite sides of a body of water W and the columns are further detailed as having screw type anchors 54. However, the anchors are just one type of anchoring that can be used, one advantage of a screw anchor being that it reduces the burden in not having to bore a hole and use cement for a footer. The flutes of the screw allow the anchor to be emplaced solely by a drilling implement when the structural grid is built. Also shown is a beam 12 with connectors 48 for securing cables or additional beams.

FIG. 25 is a side elevation view of another intermediate support for a structural grid, including a pair of columns 10 in which the structural grid also includes a truss 16 with beams 18 and braces 20. The addition of the truss 16 provides for yet additional stiffening support across the intermediate or middle portions of a structural grid.

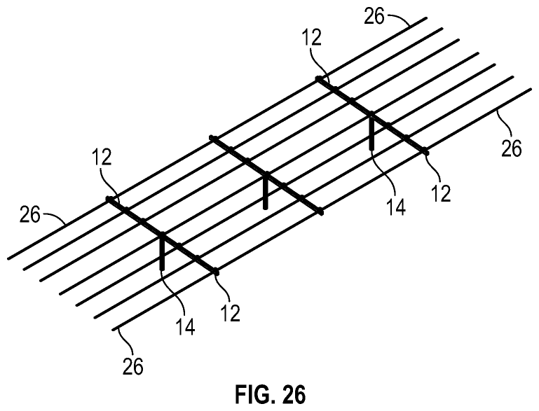

FIG. 26 is a perspective view of intermediate supports for a structural grid wherein the intermediate supports are in the form of T-column supports comprising a central column 14 and a laterally extending beam 12 bisected by the central column. This figure is similar to FIG. 4 for the T-column supports but eliminates required beams or columns at the ends of the structural grid. This figure therefore represents a structural grid that can be installed between two existing structures, such as between two buildings or between two natural features. This figure further illustrates the simplicity of design that can be achieved wherein the only required supports for the structural grid comprise a minimum number of cables, columns and beams.

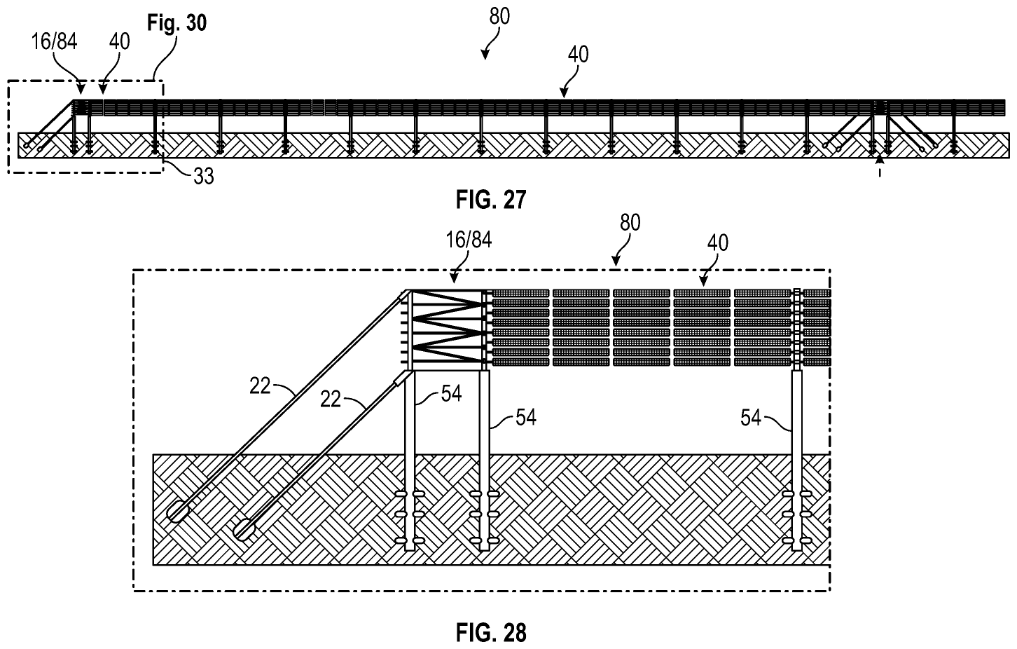

FIG. 27 is an elevation view of a structural grid supporting a load such as a plurality of solar panels 40 in which a tensioning truss 84 is used to provide additional structural support to the structural grid at one end of the structural grid. As mentioned, the trusses of the invention may be considered stiff or rigid supports, or flexible supports comprising a group of cables. Therefore, the truss 84 in this figure could represent either a rigid truss or a flexible tensioned truss. FIG. 28 is an enlarged elevation view of a portion of FIG. 27 showing the truss 16/84 located at the end of the structural grid. The presentation of the solar panels 40 and the members of the truss 16 are intended to represent that the truss can be oriented at any desired angle for supporting the load which itself might be presented at an angle for maximizing sunlight capture. FIG. 28 further shows columns with screw type anchors 54 and anchor cables 22 that extend diagonally downward from the exterior edge of the truss.

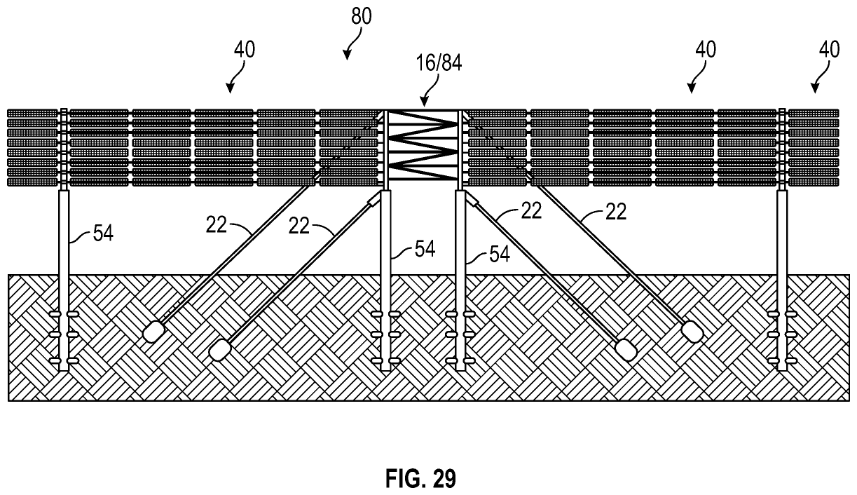

FIG. 29 is an enlarged elevation view of a truss 16 located between sections or bays of two adjacent structural grids. This illustrated truss may again represent a flexible tensioned truss or a rigid truss. Also shown are the anchor cables 22 that are reversed oriented so that tie down forces can be applied to both trusses at their respective facing ends and the truss can be used to provide continuous support across the gap or space between the facing ends. The truss may therefore be considered one efficient way in which to extend the length of any structural grid by adequately securing two separate structural grids without excessive anchors or columns that might otherwise be designed.

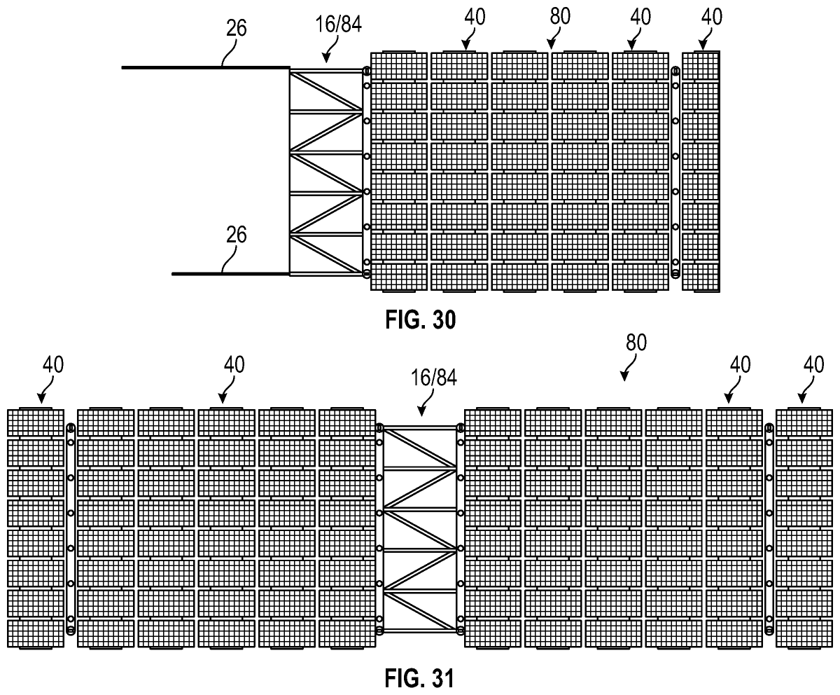

FIG. 30 is a plan view of the truss shown in FIG. 29 and the solar panel load on one side of the truss. FIG. 31 is the plan view of FIG. 30 further adding a load on the left side of the figure, such as additional solar panels. These figures are provided to further visualize how the truss may be incorporated between the two structural grids.

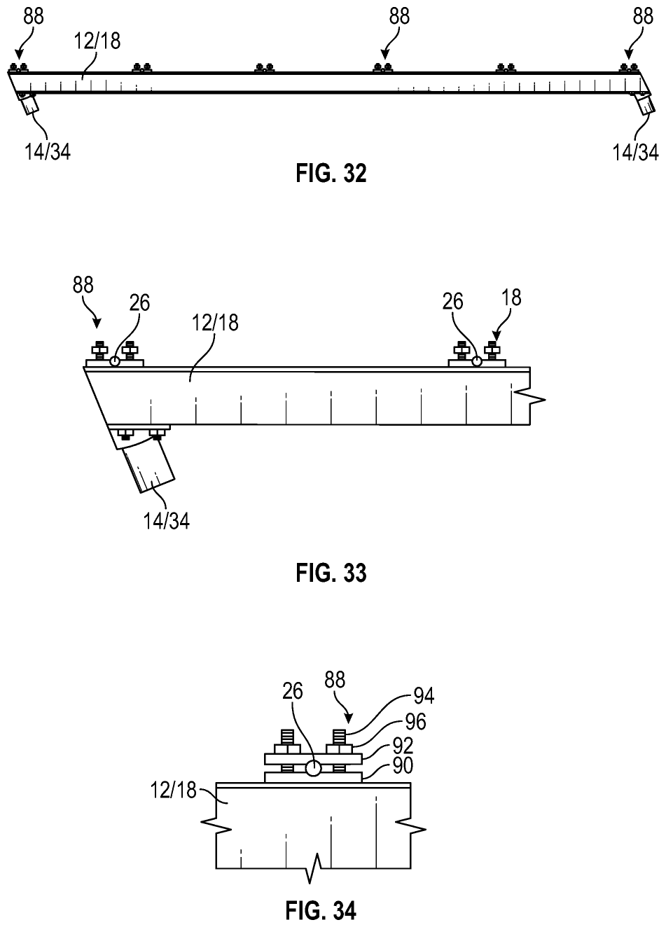

FIG. 32 is an elevation view of a beam 12/18 and beam to cable connectors 88 in which the connectors are mounted to the upper surface of the beam. FIG. 33 is an enlarged view of one end of FIG. 32 showing additional details of the connectors 88. These figures also show columns 14/34 secured to the ends of the beam 14/34.

FIG. 34 is an enlarged view of one of the beam to cable connectors 88 with a top compression plate installed to capture and hold a cable 26. More specifically, the cable connector 88 is shown as having a base plate 90, a pair of bolts 92 secure to the base plate, and two corresponding bolts that are threaded over the bolts 96. When the cable 26 is connected during assembly of the structural grid, the cable is first placed in the gap between the bolts 94, the top compression plate 92 is placed over the bolts, noting the plate 92 has holes (not shown) to receive the bolts, and the bolts are tightened thereby securely fastening the cable to the beam.

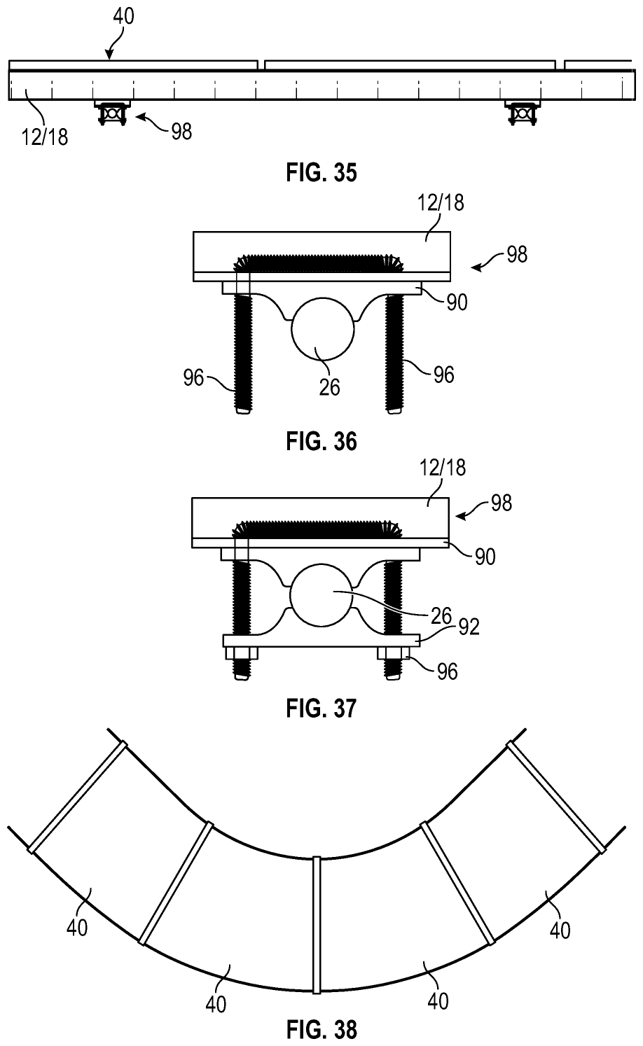

FIG. 35 is an elevation view of another beam 12/18 and beam to cable connectors 98 in which the connectors 98 are mounted to the lower surface of the beam. FIG. 36 is an enlarged view of one of the beam to cable connectors 98 of FIG. 35 with a bottom plate removed. FIG. 37 is an enlarged view of the beam to cable connector 98 of FIG. 36 showing the bottom compression plate installed. The details of the connector 98 is best seen in FIGS. 36 and 37 wherein the connector includes a base plate 90, bolts 96, a compression plate 92 and bolts 96. The operation of the connector 98 is the same as the connector 88, only the connector 98 being shown as secured to the lower surface of the beam and wherein the shapes of the plates 90 and 92 include complementary curved slots that receive the cable 26. When the bolts are tightened, the compression plate 92 places adequate compression on the cable 26 to keep it in place.

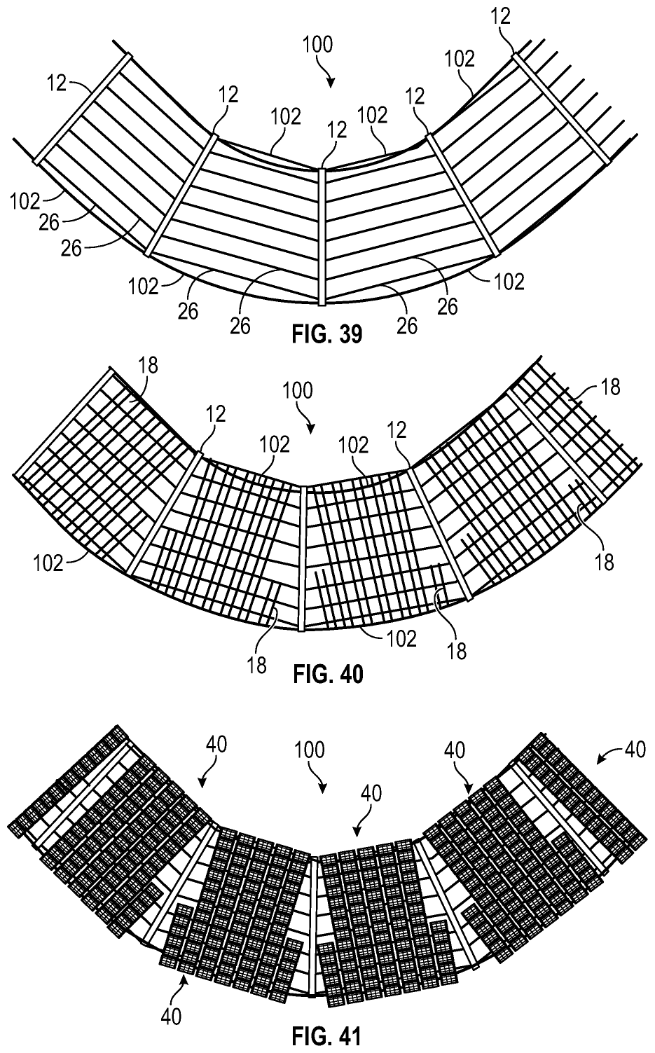

FIG. 38 is a plan view of one example of a structural grid 100 assembled to cover a curved area. The curved area could represent any geographical location in which the grid 100 is installed and the structural grid is curved to accommodate an obstacle that prevents the grid from simply extending in a linear fashion. The obstacle could be a terrain feature, a building, or any other man-made structure. FIG. 39 is the plan view of FIG. 39 adding an arrangement of cables 26 showing that the cables may also include an outer support member 102 that may represent a larger more robust cable 102 or element 102 could represent a curved rigid member that provides stiffening support to the exterior sides of the structural grid. FIG. 40 is a plan view of FIG. 39 further adding an arrangement of beams 12 and 18 incorporated with the cables 26. As shown, some of the beams 18 only traverse a partial portion of the width of the structural grid while other beams extend the entire width of the grid. FIG. 41 is the plan view of FIG. 40 further adding an arrangement of loads such as solar panels 40. As with the beams 18, some of the solar panels 40 only extend across a portion of the width of the structural grid. What is clear from the FIGS. 38-40 is that the design of the structural grid can be adopted for a curved area and the structural grid does not have to cover only linear areas with straight extensions of widths and lengths of the structural grid.

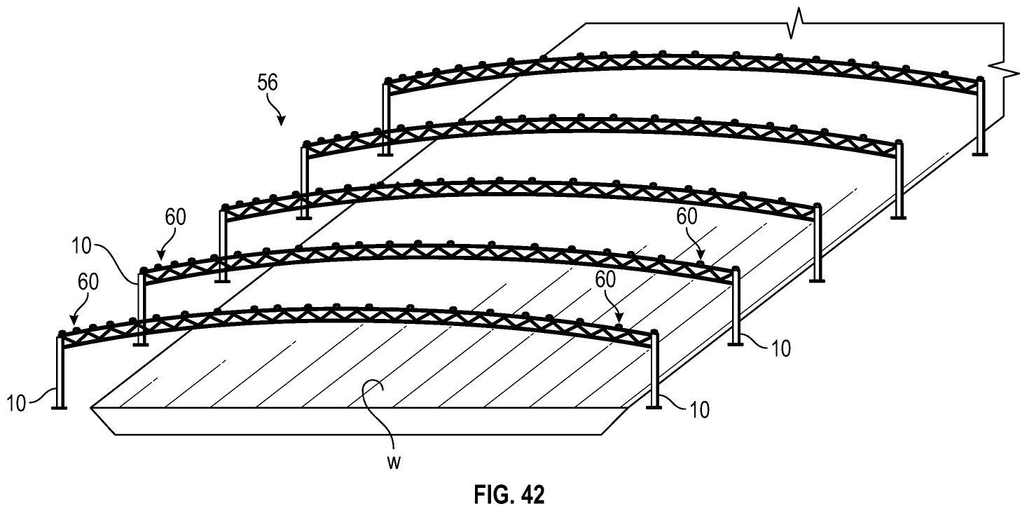

FIG. 42 is a perspective view of intermediate supports for a structural grid wherein the intermediate supports are provided in the form of trusses 60 that are arranged for the structural grid to cover a long span, such as a span crossing a large body of water W. The trusses 60 are shown as being spaced from one another along a length of the body of water and the trusses have a curvature that peaks at the center line of the body of water as the trusses are oriented. Columns 10 are located on opposite banks of the body of water and the columns 10 are intended to represent any combination of vertical support members that can carry the compression loads introduced by the trusses 60. Accordingly, the columns 10 could include multiple adjacent columns or columns with bracing, such as shown in FIG. 4.

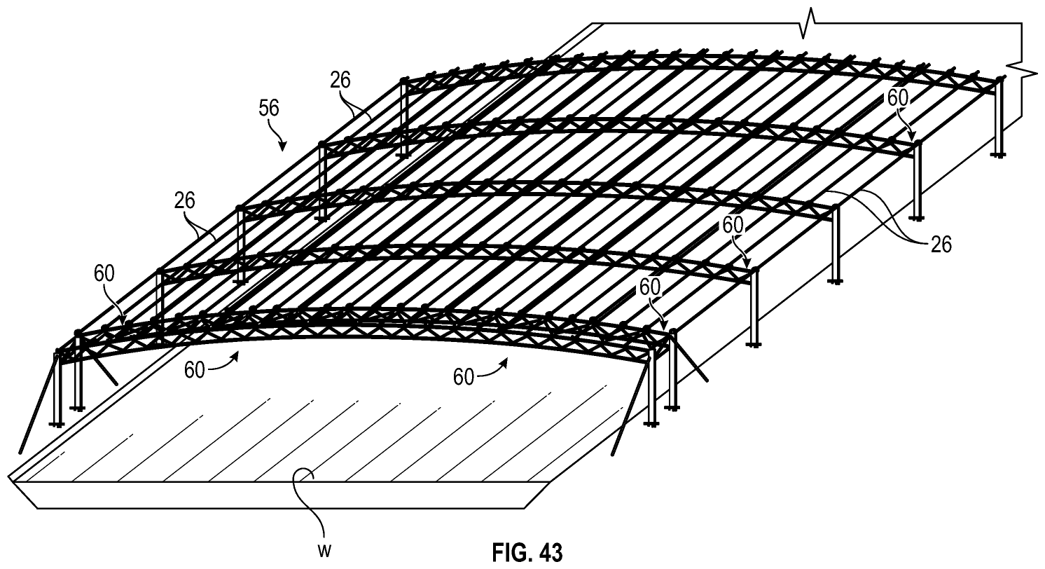

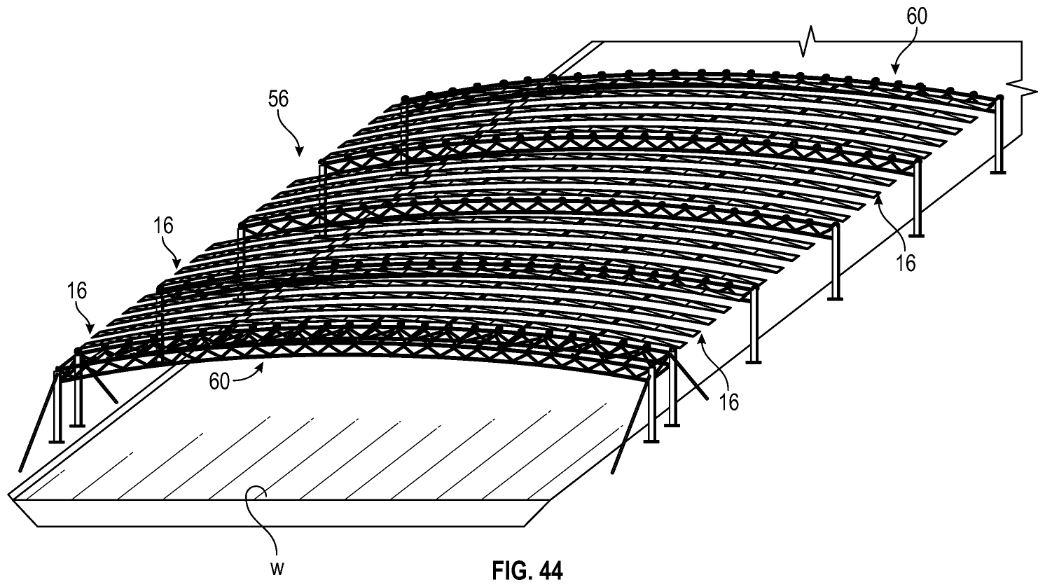

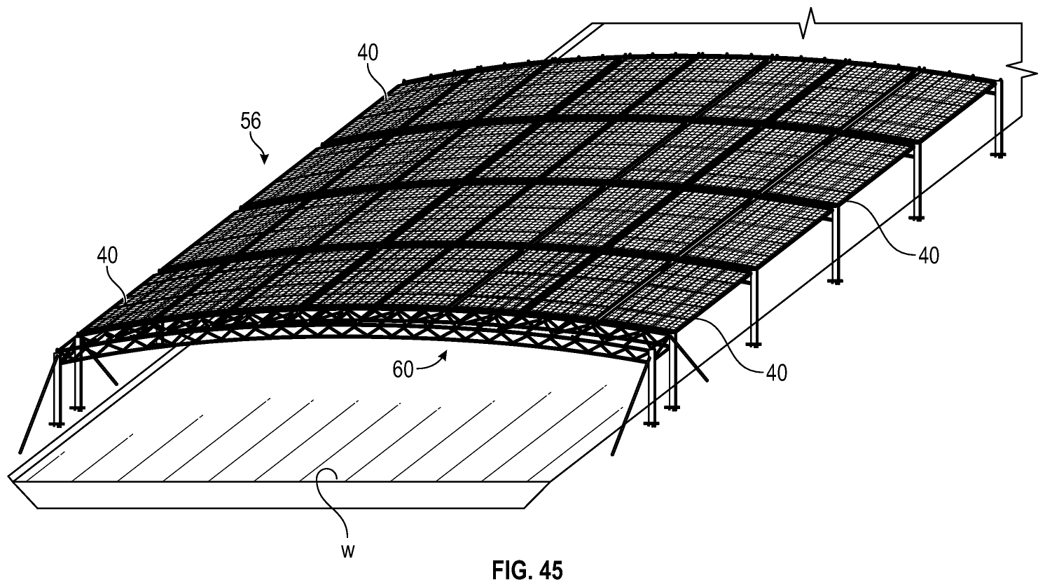

FIG. 43 is the perspective view of FIG. 42 further adding a plurality of cables 26 and adding an additional truss 60 located near one end of the structural grid. This figure also represents a long span embodiment 56 of the invention wherein the shape of the trusses 60 are capable of handling large loads for a span that must extend over a relatively long span or distance. FIG. 44 is the perspective view of FIG. 43 further adding a plurality of trusses 16 each containing multiple beams, noting the cables 26 are deleted in this figure for clarity purposes to better visualize the arrangement of the trusses 16. What can be appreciated from this figure is the robust nature of the structural grid in which the same design of trusses 60 can be repeated along a length of a body of water, therefore indicating that the structural grid can be employed not only across a span of a large body of water, but also along great lengths of the body of water. FIG. 45 is a perspective view of the embodiment of FIG. 43 and further adding a load, such as a plurality of solar panels.

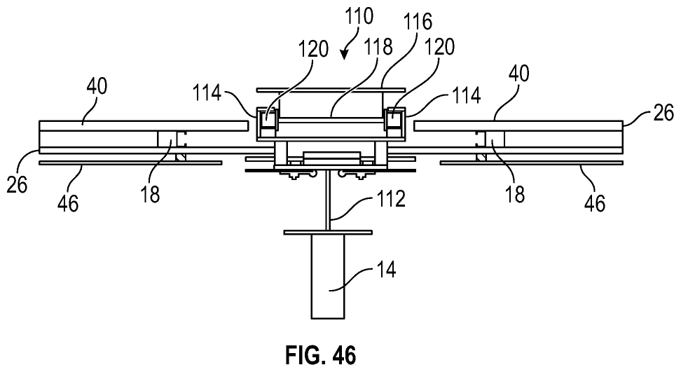

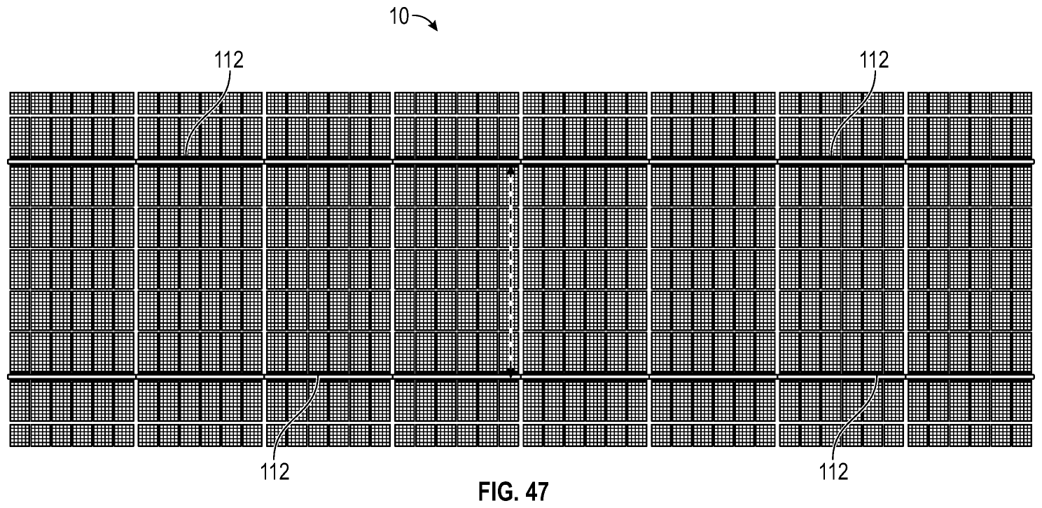

FIG. 46 is a cross-sectional view of a portion of a structural grid including a service access/automatic cleaning trolley assembly 110 that can be traversed along a structural grid by a guide rail structure. More specifically, this figure illustrates a rail guide 114 which is used to guide the assembly 110. The device has a mounting surface 116 that is used to mount a cleaning component or a service component that can be used to repair or otherwise service the solar panels. The assembly 110 moves within the rail guide by wheels 120 that are received in corresponding channels of the rail guide 114. An axle 118 extends between the wheels 120 and causes the wheels to spin together to prevent binding within the channels as the device moves. The assembly 110 is shown as being mounted between two adjacent solar panels wherein a column 14 at its upper end has mounted thereto a trolley beam 112. The rail guide 114 is secured on one or more supports as shown, and the lower end of said supports are mounted on the upper surface of the trolley beam 112. FIG. 47 is a plan view showing an arrangement of two trolley beams 112 on a structural grid. These trolley beams can be used to convey the service access/automatic cleaning trolley assembly 110 along any desired length of a structural grid, and the two trolley beams enable two lateral points to be used to clean or service the grid.

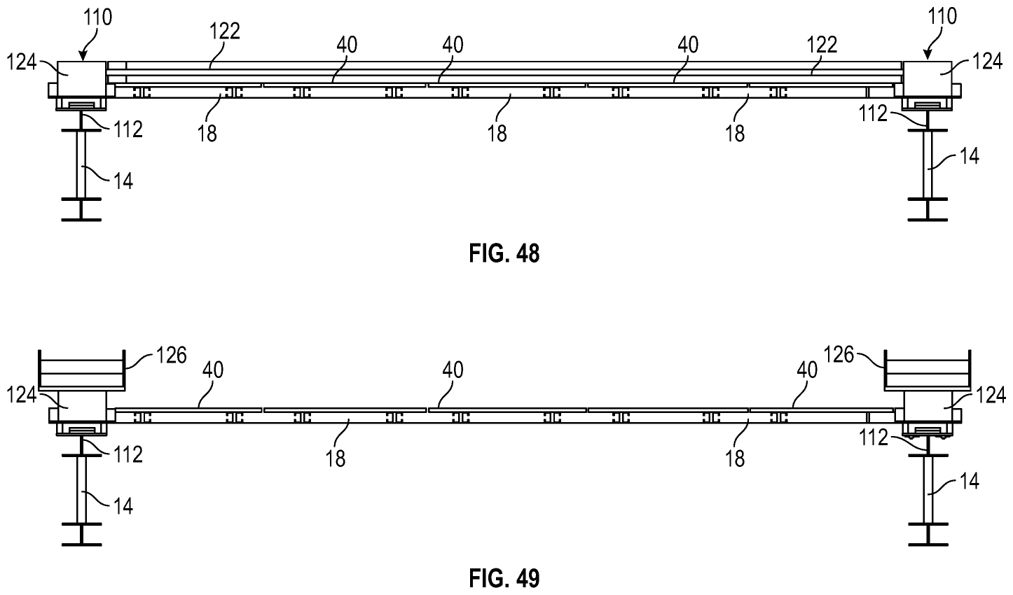

FIG. 48 is a cross-sectional elevation view of a sample structural grid in which two rails are provided to each support a trolley assembly 110 and wherein the trolley assemblies are shown to support a cleaning tube 122 extending between the trolley assemblies. The trolley assemblies are more specifically shown as having a housing 124 which could house a motor and gear device (not shown) that could be used to rotate the cleaning tube 122f as a brush and/or to convey cleaning fluid through the tube. FIG. 49 is another cross-sectional elevation view of FIG. 48 wherein the trolley assemblies are alternatively shown to each support respective pieces service equipment 126. The housings 124 could therefore represent some other functioning feature associated with the service equipment.

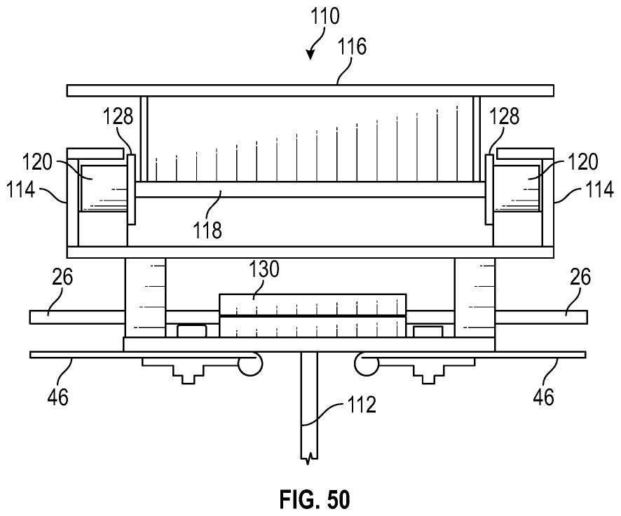

FIG. 50 is an enlarged view of the service access/automatic cleaning trolley assembly of FIG. 46 showing the same elements and further showing a clamp unit 130 that is used to connect the base of the trolley assembly to the connected cable. The clamp unit 130 can be similar to the connectors 88 and 98.

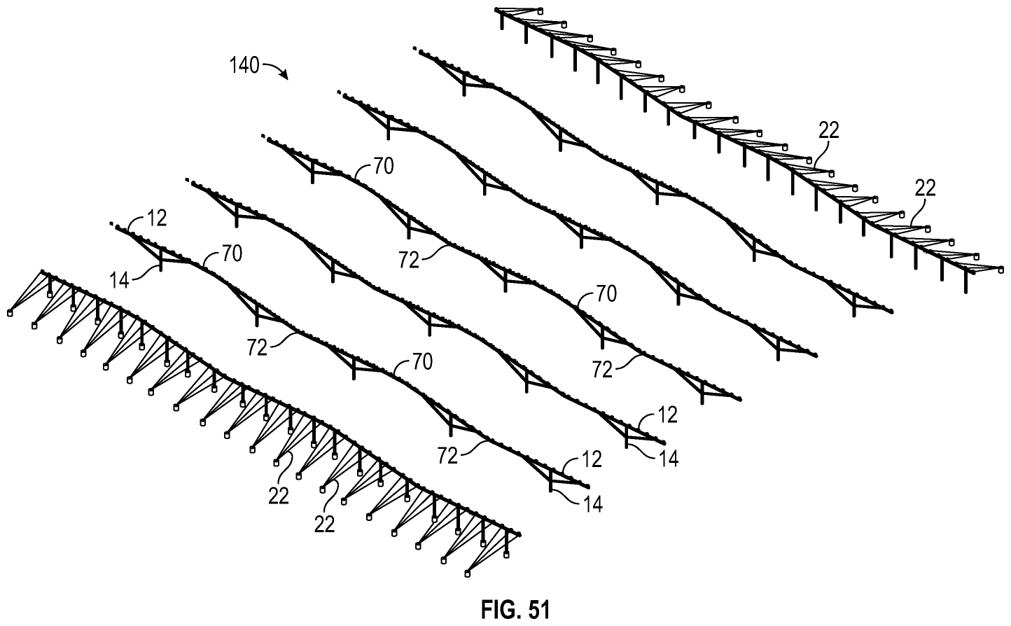

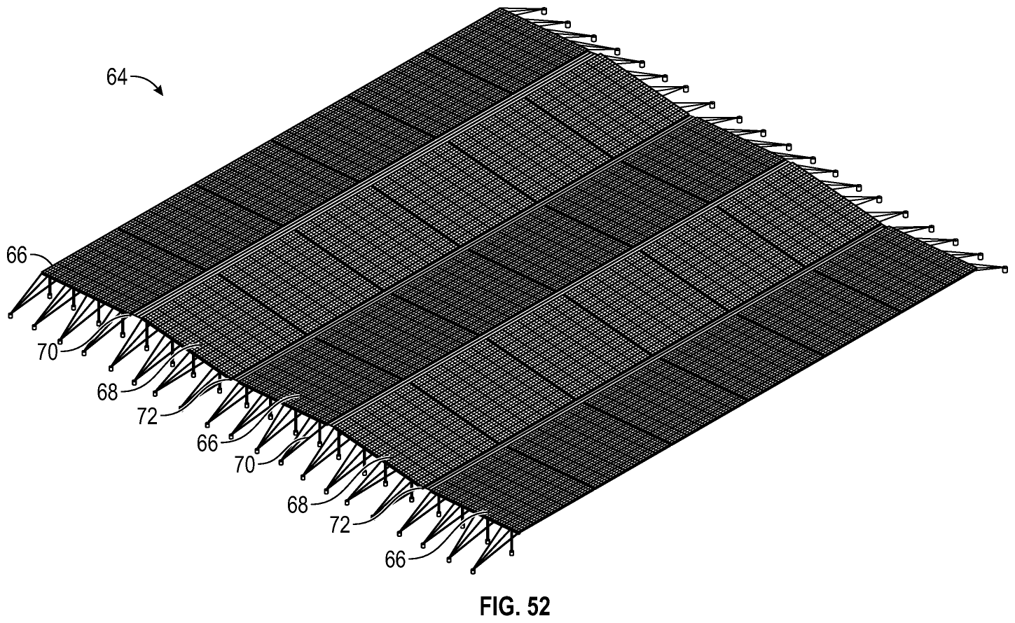

FIG. 51 is a perspective view of structural supports for a structural grid as employed for a continuous canopy embodiment 140 of the invention. The structural supports for the grid include a number of spaced beam and column combinations 70 including intermediate columns and beams with diagonal bracing. Also shown are the curved shapes of the beams in which the beams define a series of apexes 70 and troughs 72 which enable the load to have surfaces that extend at different angles as shown in FIG. 52. FIG. 52 is a perspective view of FIG. 51 showing a load added to the system, such as solar panels, in which a continuous canopy or covering of the area is achieved and wherein the solar panels are selectively angled in a pattern 66 that may be advantages for sunlight capture, shading or combinations thereof.

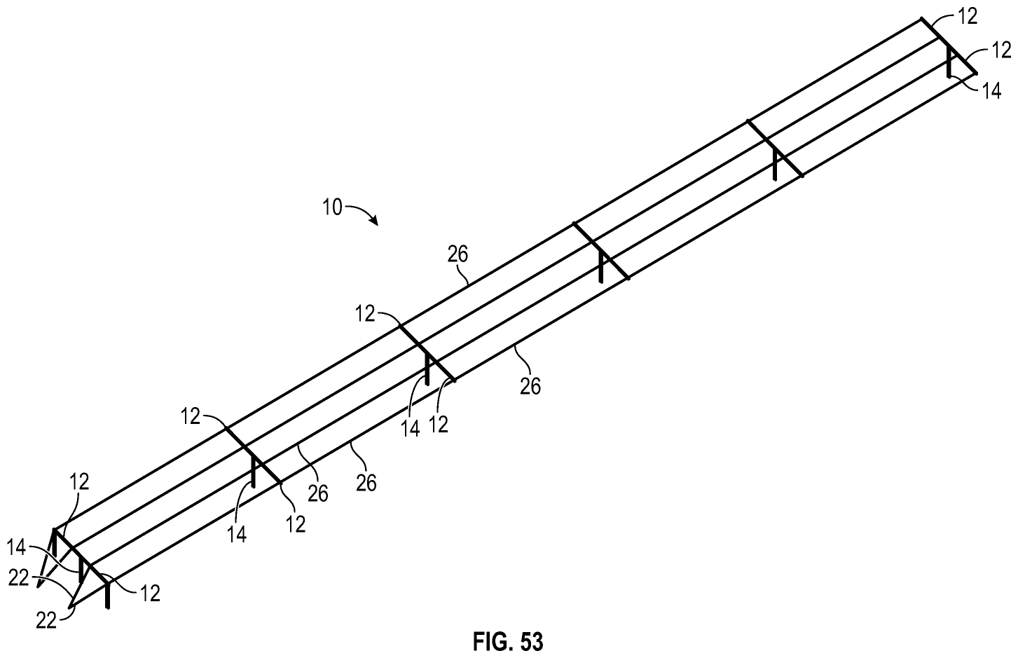

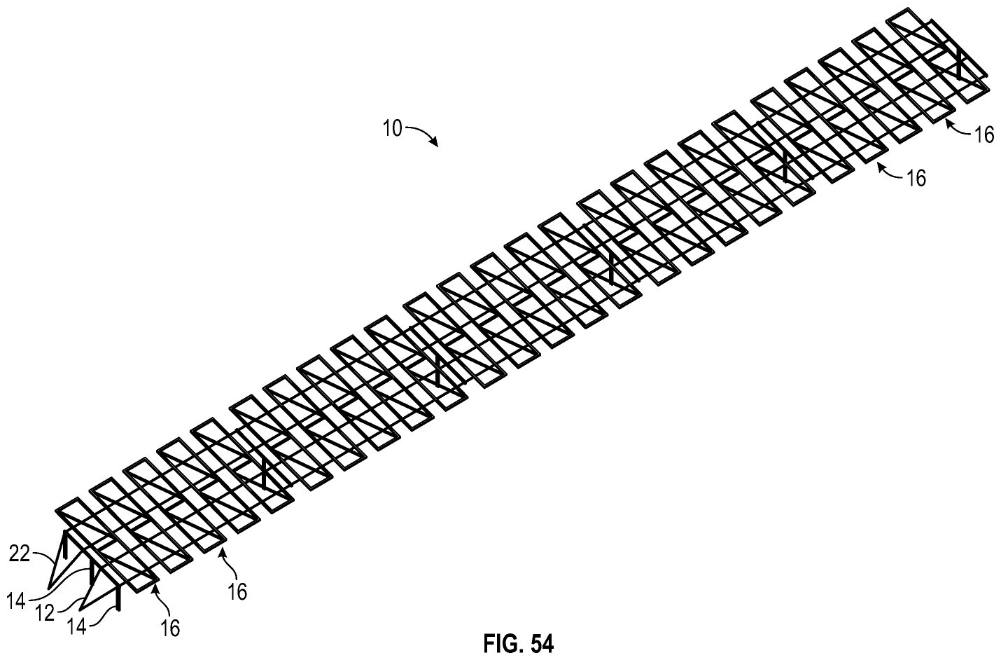

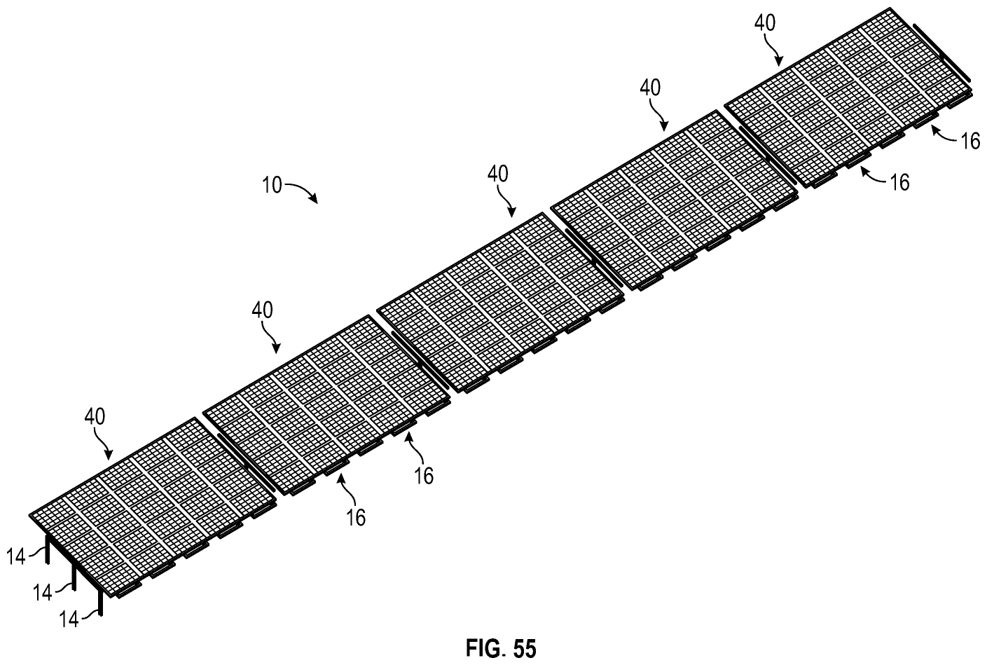

FIG. 53 is a perspective view of a short span system of the invention provided to illustrate that only a minimum number of structural supports are employed in a simplified structural grid as compared to prior art systems in which a much greater number of rigid structural supports are required. As shown, the short span includes a minimum number of cables 26, T-braces or T-columns composed of columns 14 and beams 12, and anchor cables 22. FIG. 54 is the perspective view of FIG. 53 further adding a plurality of trusses 16 to form the structural grid. FIG. 55 is a perspective view of FIG. 54 further showing a load added to the structural grid such as solar panels 40.

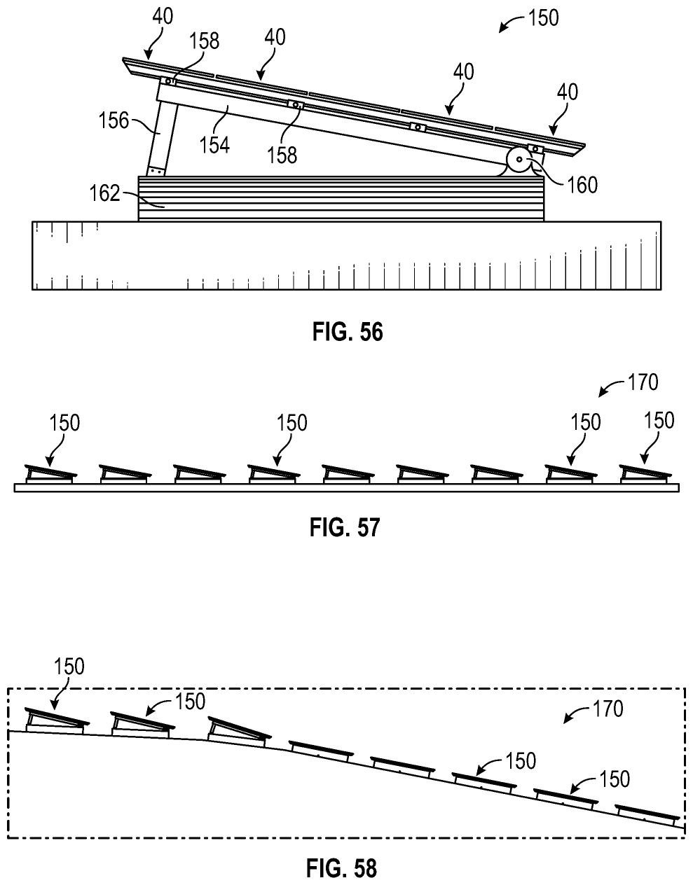

FIG. 56 is a side elevation view of another structural grid embodiment of the invention showing a structural grid 150 that is especially adapted for ground mounting in which the structural grid includes an above-ground base support and a low-profile presentation of solar panels at a desired angular orientation. Specifically, this figure shows a ground mounted structural grid 150 comprising a support beam 154 upon which a load is placed such as solar panels 40. An angled support 156 is used to provide the desired tilt or angle for the grid. One or more connectors 158 are used to secure the load to the beam 154. one end of the beam 154 is connected to a rotatable connector 160 that enables the load to be angled based on the length of the angled support 156. The grid is mounted on a foundation 162 which can be, for example, a concrete foundation that overlies the ground.

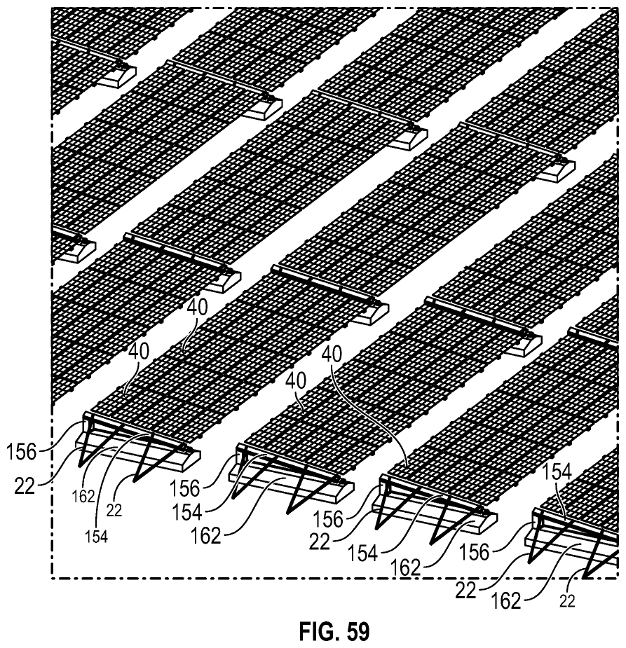

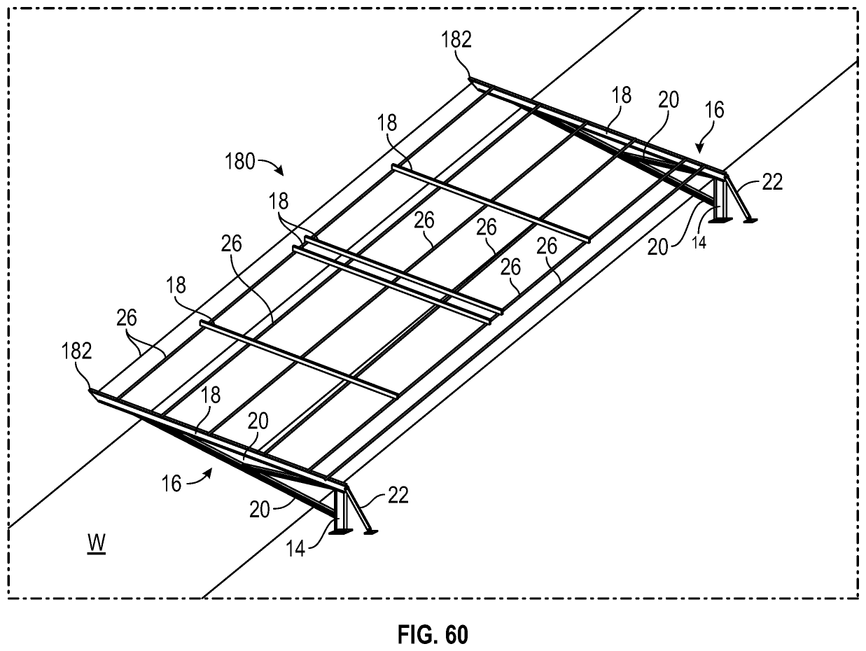

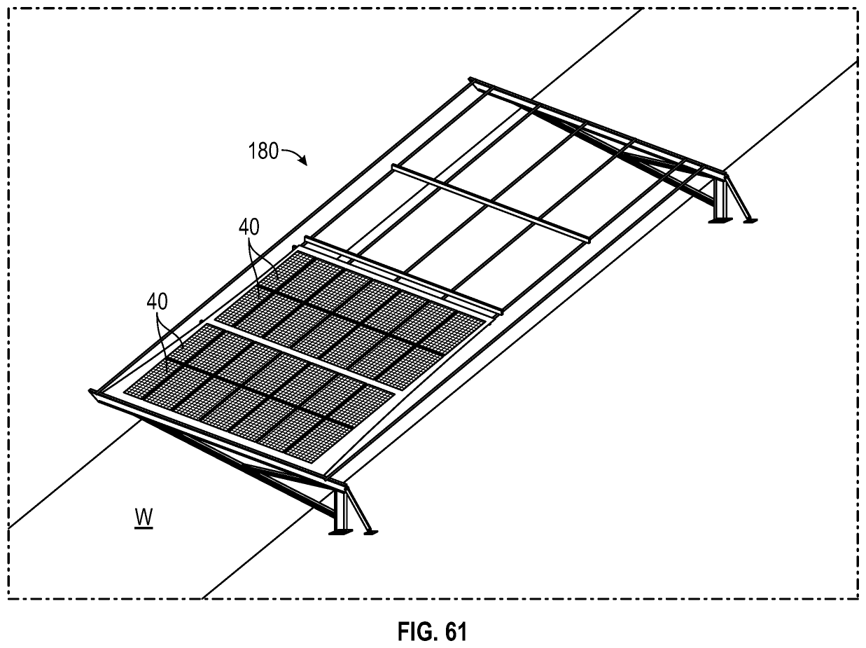

FIG. 57 is a side elevation view of a plurality of structural grids forming embodiment 170 which is shown as being installed on a relatively flat ground surface and wherein there are a plurality of rows of structural grids 150 spaced from one another. FIG. 58 is a side elevation view of the structural grid embodiment 170 of FIG. 57 showing a plurality of rows of structural grids 150 and mounted solar panels spaced from one another on a sloping ground surface. FIG. 59 is a perspective view of the structural grid embodiment 170 of FIG. 57 showing the structural grids and mounted solar panels.

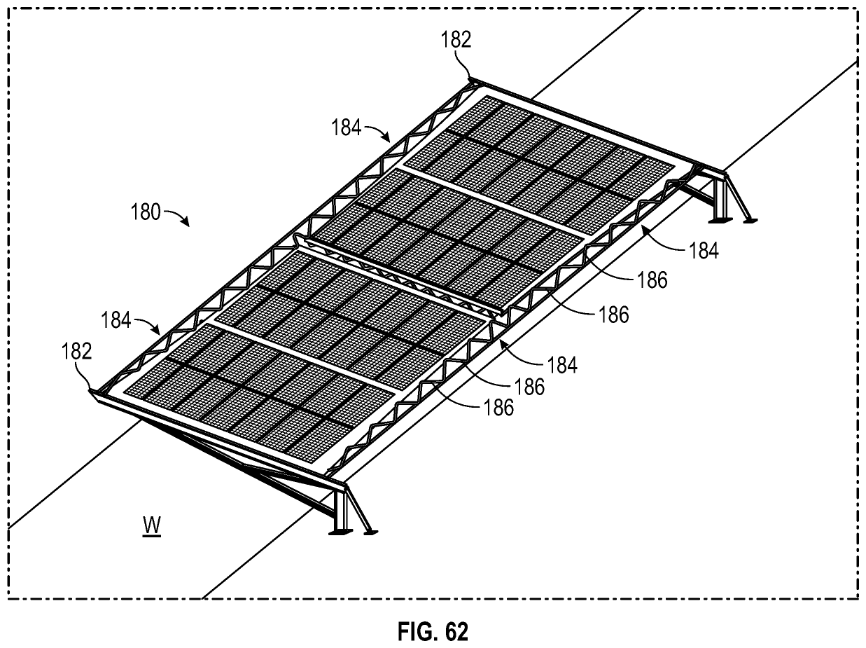

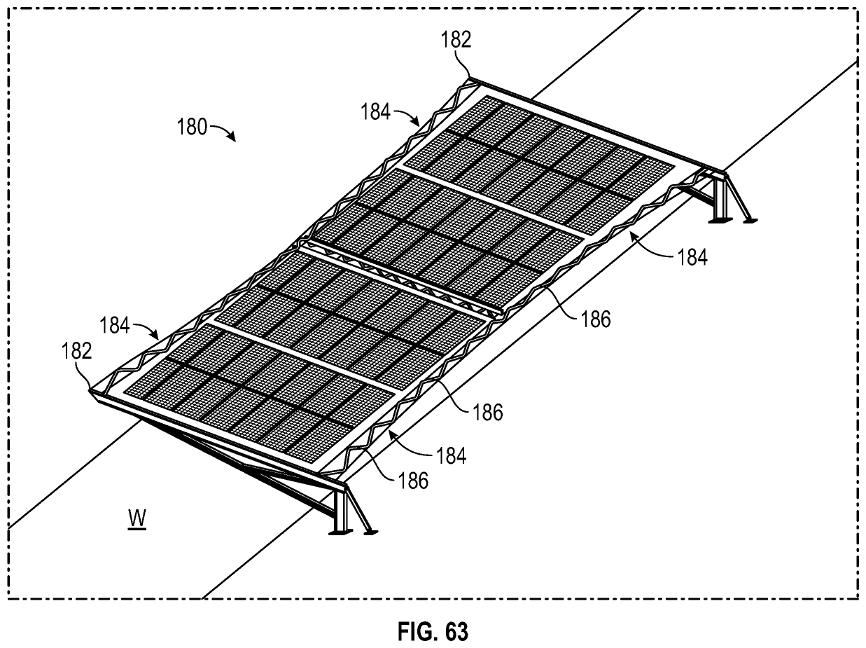

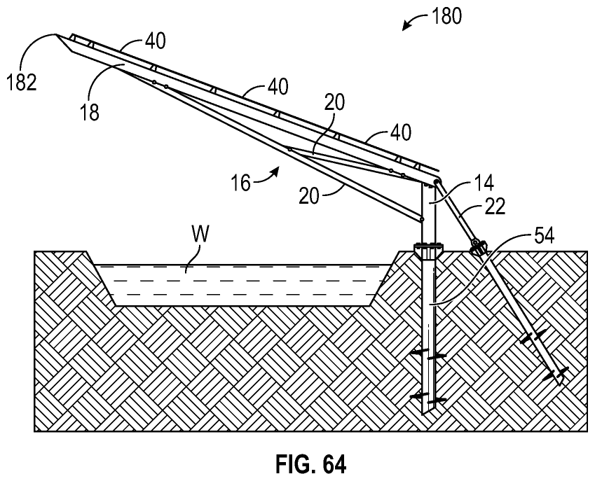

FIG. 60 is a perspective view of a structural grid in connection with another embodiment of the invention in the form of a cantilever design 180 in which a first side of the structural grid is anchored and the opposite second side 182 extends away from the first side and the second side 182 is not supported by a column or any other support. FIG. 61 is the perspective view of FIG. 60 further adding a load such as solar panels 40 on one end of the structural grid. FIG. 62 is the perspective view of FIG. 61 showing solar panels 40 mounted on both ends of the structural grid and further showing tensioning trusses 184 located on both sides of the structural grid and a tensioning truss 184 located between midway between the two groups of solar panels. The tensioning trusses 184 are shown as having a crossing pattern of a cable 186 in each truss. FIG. 63 is the perspective view of FIG. 62 showing the tensioning trusses 184 as being tightened thereby decreasing the widths of the tensioning trusses to indicate increased tensioning support provided by the structural grid. The cable 186 in each truss is pulled and tightened to a desired tension level to place the structural grid in a desired configuration. FIG. 64 is an enlarged side elevation view of the cantilever design of FIG. 60 showing one of the column and beam combinations making up the structural grid of the embodiment. As shown, the cantilever design includes the column 14, cable 22, beam 18 and braces 20. The free end 182 extends at an angle above a body of water 182. The load is a solar panel 40.

1. A structural grid comprising:
a plurality of cables;
a plurality of beams connected to the cables;
a plurality of columns connected to the beams and cables to suspend a load above the ground;
wherein the load is mounted over the cables and beams;
a plurality of connectors to attach the load to the cables and beams; and
wherein the columns have one end secured within the ground on to the ground.

2. The structural grid of claim 1, wherein:
said plurality of beams further includes a plurality of braces, and wherein a combination of beams and braces form a truss.

3. The structural grid of claim 1, wherein:
the structural grid includes a plurality of trusses.

4. The structural grid of claim 1, wherein:
the structural grid is mounted over a body of water in which a first side of the structural grid is placed on one bank of the body of water, and a second side of the structural grid is placed on an opposite bank of the body of water.

5. The structural grid of claim 1, further including:
a cleaning/service trolley assembly secured to the beams and cables wherein the trolley assembly is moveable along a selected length of the structural grid.

6. The structural grid of claim 1, wherein:
the structural grid is a cantilever design comprising a fist end of the structural grid secured by columns to the ground and a second opposite end of the structural grid extending away from the first end and said second end not being connected to any structure.

7. The structural grid of claim 1, wherein:
the structural grid has a linear shape with lateral sides that are substantially parallel to one another and longitudinal sides that are substantially parallel to one another, and wherein the lateral and longitudinal sides are substantially orthogonal to one another.

8. The structural grid of claim 1, wherein:
the structural grid has a non-linear shape.

9. A structural grid comprising:
a plurality of cables;
a plurality of beams connected to the cables;
a plurality of columns connected to the beams and cables to suspend a load above the ground;
wherein the load is mounted over the cables and beams;
a plurality of connectors to attach the load to the cables and beams;
wherein the columns have one end secured within the ground on to the ground;
wherein a selected group of beams form a truss, and said structural grid includes a plurality of trusses spaced along selected portions of the structural grid.

10. The structural grid of claim 9, wherein;
the structural grid forms a long span.

11. The structural grid of claim 1, wherein:
the structural grid forms a short span.

12. The structural grid of claim 1, wherein:
a first load is secured to an upper surface of the structural grid and a second load is secured to a lower surface of the structural grid.

13. The structural grid of claim 9, wherein:
a first load is secured to an upper surface of the structural grid and a second load is secured to a lower surface of the structural grid.

14. The structural grid of claim 1, wherein:
the load is a shade cover.

15. The structural grid of claim 1, wherein:
the load is solar panels.

16. The structural grid of claim 9, wherein:
the load is a shade cover.

17. The structural grid of claim 9, wherein:
the load is solar panels.
